(19) United States
(12) Patent Application Publication
(10) Pub. No.: US 2025/0102454 A1
(43) Pub. Date: Mar. 27, 2025

(54) ANALYSIS METHOD AND ANALYSIS APPARATUS

(71) Applicants: MURATA MANUFACTURING CO., LTD., Kyoto (JP); NIIGATA UNIVERSITY, Niigata (JP)

(72) Inventors: Mitsunori NAKAMOTO, Kyoto (JP); Kouta ENDOU, Kyoto (JP); Kikou YAMAGUCHI, Kyoto (JP); Shinichi KATAYAMA, Kyoto (JP); Izaya OKAE, Kyoto (JP); Yasuhiro UMEBAYASHI, Kyoto (JP)

(21) Appl. No.: 18/975,376

(22) Filed: Dec. 10, 2024

Related U.S. Application Data
(63) Continuation of application No. PCT/JP2023/033319, filed on Sep. 13, 2023.

(30) Foreign Application Priority Data
Sep. 30, 2022 (JP) 2022-157924

(51) Int. Cl. G01N 27/02; G01N 27/06

(52) U.S. Cl. CPC G01N 27/026; G01N 27/06

(57) ABSTRACT

An analysis method includes: calculating dynamical behavior of a series of atoms included in a constituent component of an electrolytic solution by performing a molecular dynamics calculation regarding the electrolytic solution; calculating a first dielectric relaxation spectrum signal of the constituent component, based on the dynamical behavior of the series of atoms; calculating a second dielectric relaxation spectrum signal of the electrolytic solution, based on the first dielectric relaxation spectrum signal; and calculating a physical property value unique to the constituent component, based on the first dielectric relaxation spectrum signal and the second dielectric relaxation spectrum signal.

### CROSS REFERENCE TO RELATED APPLICATIONS

The present application is a continuation of International patent application no. PCT/JP2023/033319, filed on Sep. 13, 2023, which claims priority to Japanese patent no. 2022-157924, filed on Sep. 30, 2022, the entire contents of which are incorporated herein by reference.

### BACKGROUND

The present technology is an analysis method and an analysis apparatus.

To design a configuration of an electrolytic solution to be included in a power storage device, various analysis methods and various analysis apparatuses have been proposed regarding a physical property of the electrolytic solution.

Specifically, in a preliminary consideration of the electrolytic solution, a calibration model is prepared that represents a relationship between an intensity of a complex dielectric constant and a concentration in a particular frequency band. The complex dielectric constant is thus measured in the particular frequency band, and the concentration of the electrolytic solution is determined based on a measurement result of the complex dielectric constant.

In addition, nuclear magnetic resonance (NMR) is used to determine a rotational correlation time of a molecule, a molecular weight, and a molecular volume, based on a spectrum signal obtained from an electrolytic solution in relation to a magnetic field.

### SUMMARY

The present technology is an analysis method and an analysis apparatus.

Although consideration has been given in various ways as to an analysis method and an analysis apparatus to analyze a physical property of an electrolytic solution, the analysis method and the analysis apparatus still remain insufficient in analysis level. Accordingly, there is still room for improvement in terms of the analysis level.

Provided are an analysis method and an analysis apparatus that each make it possible to easily and highly accurately analyze a physical property of an electrolytic solution.

An analysis method according to an embodiment of the present technology includes: calculating dynamical behavior of a series of atoms included in a constituent component of an electrolytic solution by performing a molecular dynamics calculation regarding the electrolytic solution; calculating a first dielectric relaxation spectrum signal of the constituent component, based on the dynamical behavior of the series of atoms; calculating a second dielectric relaxation spectrum signal of the electrolytic solution, based on the first dielectric relaxation spectrum signal; and calculating a physical property value unique to the constituent component, based on the first dielectric relaxation spectrum signal and the second dielectric relaxation spectrum signal.

An analysis apparatus according to an embodiment of the present technology includes a calculator. The calculator calculates a physical property value regarding an electrolytic solution. The calculator calculates dynamical behavior of a series of atoms included in a constituent component of the electrolytic solution by performing a molecular dynamics calculation regarding the electrolytic solution. The calculator calculates a first dielectric relaxation spectrum signal of the constituent component, based on the dynamical behavior of the series of atoms. The calculator calculates a second dielectric relaxation spectrum signal of the electrolytic solution, based on the first dielectric relaxation spectrum signal. The calculator calculates the physical property value unique to the constituent component, based on the first dielectric relaxation spectrum signal and the second dielectric relaxation spectrum signal.

According to the analysis method or the analysis apparatus of an embodiment of the present technology: the dynamical behavior of the series of atoms included in the constituent component of the electrolytic solution is calculated by performing the molecular dynamics calculation regarding the electrolytic solution; the first dielectric relaxation spectrum signal of the constituent component is calculated; the second dielectric relaxation spectrum signal of the electrolytic solution is calculated; and the physical property value unique to the constituent component is calculated. This makes it possible to easily and highly accurately analyze the physical property of the electrolytic solution.

Note that effects of the present technology are not necessarily limited to those described herein and may include any of a series of effects including described below in relation to the present technology.

### BRIEF DESCRIPTION OF THE FIGURES

FIG. 1 is a block diagram illustrating a configuration of an analysis apparatus according to an embodiment of the present technology.

FIG. 2 is a block diagram illustrating a configuration of an analysis apparatus according to an embodiment.

FIG. 3 is a calculation result of a time correlation function in Example 1.

FIG. 4 is an approximation result of the time correlation function in Example 1.

FIG. 5 is a calculation result of an individually calculated dielectric relaxation spectrum signal (a dielectric constant real part) and a calculated dielectric relaxation spectrum signal (a dielectric constant real part) in Example 1.

FIG. 6 is a calculation result of the individually calculated dielectric relaxation spectrum signal (a dielectric constant imaginary part) and the calculated dielectric relaxation spectrum signal (a dielectric constant imaginary part) in Example 1.

FIG. 7 is a calculation result of the calculated dielectric relaxation spectrum signal (the dielectric constant real part and the dielectric constant imaginary part) in Example 1.

FIG. 8 is a measurement result of a measured dielectric relaxation spectrum signal (a dielectric constant real part and a dielectric constant imaginary part) in Example 1.

FIG. 9 is a calculation result of an individually calculated dielectric relaxation spectrum signal (a dielectric constant imaginary part) and a calculated dielectric relaxation spectrum signal (a dielectric constant imaginary part) in Example 2.

FIG. 10 is a calculation result of the calculated dielectric relaxation spectrum signal (a dielectric constant real part and the dielectric constant imaginary part) in Example 2.

FIG. 11 is a measurement result of a measured dielectric relaxation spectrum signal (a dielectric constant real part and a dielectric constant imaginary part) in Example 2.

FIG. 12 is a calculation result of an individually calculated dielectric relaxation spectrum signal (a dielectric constant imaginary part) in Example 3 (a three-component system).

FIG. 13 is a calculation result of an individually calculated dielectric relaxation spectrum signal (a dielectric constant imaginary part) in Example 3 (a two-component system).

FIG. 14 is a calculation result of a calculated dielectric relaxation spectrum signal (a dielectric constant real part and a dielectric constant imaginary part) in Example 3.

FIG. 15 is a measurement result of a measured dielectric relaxation spectrum signal (a dielectric constant real part and a dielectric constant imaginary part) in Example 3.

### DETAILED DESCRIPTION

The present technology is described below in further detail including with reference to the drawings according to an embodiment.

First, a description is given of an analysis apparatus according to a first embodiment of the present technology.

Note that an analysis method according to the first embodiment of the present technology is described together below, because the analysis method is describable by describing here an operation (an analysis procedure) of the analysis apparatus.

The analysis apparatus is used to analyze a physical property of an electrolytic solution. An analysis result of the physical property is to be used as a guide for designing a configuration of an electrolytic solution having desired performance. The electrolytic solution includes one or more constituent components. The analysis apparatus analyzes a physical property of the electrolytic solution as a whole, and also analyzes a physical property of each of the one or more constituent components included in the electrolytic solution.

The one or more constituent components described above include any one or more kinds selected from neutral molecules or ion pairs. Only one kind of neutral molecule may be used, or two or more kinds of neutral molecules may be used. Similarly, only one kind of ion pair may be used, or two or more kinds of ion pairs may be used. Details of each of the neutral molecules and the ion pairs will be described later.

The electrolytic solution is a liquid electrolyte having ionic conductivity, and includes a solvent and an electrolyte salt. Details of each of the solvent and the electrolyte salt will be described later. An application of the electrolytic solution is not particularly limited, and examples thereof include a power storage device such as a battery or a capacitor. The battery may be a primary battery or a secondary battery.

It is thus possible to design the configuration of the electrolytic solution having the desired performance, based on an analysis result of the electrolytic solution obtained by the analysis apparatus. Therefore, the analysis method in which the analysis apparatus is used is useful for, for example, research and development, design, and quality control of the electrolytic solution to be used in various applications.

In more detail, mobility (in particular, a rotational motion) of each of the constituent components included in the electrolytic solution is an important factor that greatly influences an ion transport property of the electrolytic solution. Therefore, an analysis of the electrolytic solution by the analysis apparatus makes it possible to find out the physical property of the electrolytic solution as a whole, which reflects a physical property derived from the mobility of each of the constituent components, and also makes it possible to find out the physical property of each of the constituent components derived from the mobility of corresponding one of the constituent components. It is thus possible to easily and highly accurately design a configuration of an electrolytic solution having a superior ion transport property.

In particular, in order to analyze the physical property of the electrolytic solution, more specifically, the physical property of each of the constituent components included in the electrolytic solution, the analysis apparatus described here calculates a dielectric relaxation spectrum (Dielectric relaxation spectrum) signal of each of the constituent components, based on a molecular dynamics (Molecular dynamics) calculation.

Hereinafter, the molecular dynamics calculation is referred to as an “MD calculation”, and the dielectric relaxation spectrum signal is referred to as a “DRS signal”.

The MD calculation is a simulation in which dynamical behavior of a series of atoms included in each of the constituent components is calculated. The DRS signal is a signal representing dielectric behavior of a substance, i.e., what is called a complex dielectric constant spectrum signal, and includes a dielectric constant real part and a dielectric constant imaginary part.

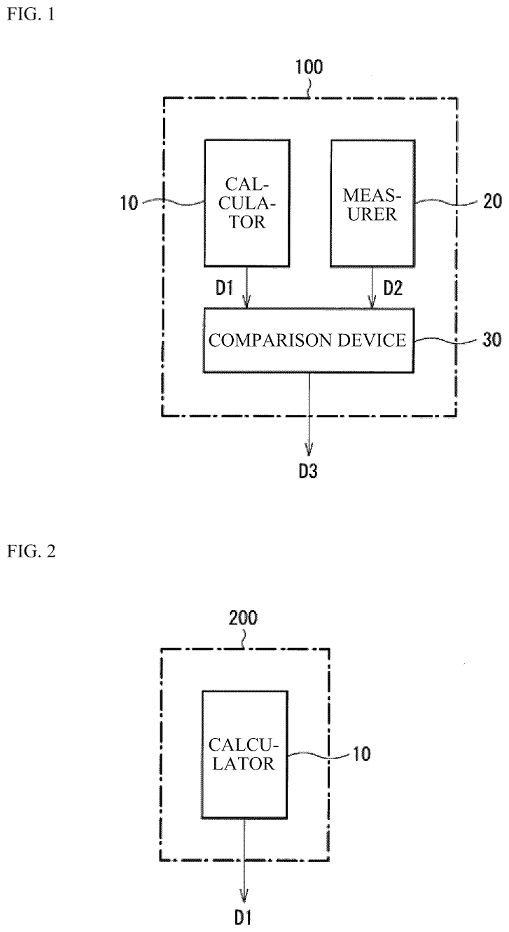

FIG. 1 illustrates a block configuration of an analysis apparatus 100 that is one specific example of the analysis apparatus according to the first embodiment. The analysis apparatus 100 includes a calculator 10, a measurer 20, and a comparison device 30, as illustrated in FIG. 1.

The calculator 10 calculates a physical property value P regarding an electrolytic solution including a constituent component C. As described above, only one constituent component C may be used, or two or more constituent components C may be used. In addition, the physical property value P is not particularly limited in kind. Therefore, only one kind of physical property value P may be calculated, or two or more kinds of physical property values P may be calculated. Specifically, the one or more kinds of physical property values P include any one or more of a characteristic time, a relaxation strength, a static dielectric constant, a concentration, or a salt dissociation degree. Details of each of the characteristic time, the relaxation strength, the static dielectric constant, the concentration, and the salt dissociation degree will be described later.

The calculator 10 includes a computing device that performs a series of calculation processes including, without limitation, the MD calculation. Specific examples of the computing device include a microprocessor.

Specifically, the calculator 10 calculates dynamical behavior of a series of atoms included in the constituent component C by performing an MD calculation regarding the electrolytic solution. In the MD calculation, a temporal change in behavior, i.e., a position and energy, of each of atoms included in a substance is tracked by solving Newton's equation of motion in classical dynamics for each of the atoms.

A method (including a kind of a force field) of the MD calculation is not particularly limited as long as it is software configured to execute the MD calculation. In this case, conditions of the MD calculation may be set as desired.

In addition, the calculator 10 calculates a DRS signal of the constituent component C, based on a calculation result obtained by the MD calculation, i.e., a calculation result of the dynamical behavior of the series of atoms. Specifically, the calculator 10 calculates the DRS signal of the constituent component C, based on the calculation result obtained by the MD calculation, and calculates a DRS signal of the electrolytic solution as a whole, based on the DRS signal of the constituent component C.

The former DRS signal is the DRS signal (a first dielectric relaxation spectrum signal) of the constituent component C calculated by the calculator 10, and this DRS signal is hereinafter referred to as an “individually calculated DRS signal S1”. The latter DRS signal is the DRS signal (a second dielectric relaxation spectrum signal) of the electrolytic solution calculated by the calculator 10, and this DRS signal is hereinafter referred to as a “calculated DRS signal S2”.

When one constituent component C is used, the calculator 10 calculates the individually calculated DRS signal S1, and thereafter sets the individually calculated DRS signal S1 to the calculated DRS signal S2. When two or more constituent components C are used, the calculator 10 calculates the individually calculated DRS signal S1 of each of the constituent components C, and thereafter calculates the calculated DRS signal S2 by adding up the respective individually calculated DRS signals S1 of the constituent components C.

One reason why the calculator 10 calculates the individually calculated DRS signal S1 of the constituent component C in addition to the calculated DRS signal S2 of the electrolytic solution is to allow for assignment of a DRS signal (a measured DRS signal S3) measured by the measurer 20, based on the individually calculated DRS signal S1, as will be described later.

Further, the calculator 10 calculates a physical property value P unique to the constituent component C, based on the individually calculated DRS signal S1 and the calculated DRS signal S2.

Here, the calculator 10 sequentially performs calculation processes described below in order to calculate the individually calculated DRS signal S1. That is, the calculator 10 calculates a total electric dipole moment of the constituent component C, based on the calculation result obtained by the MD calculation. Further, the calculator 10 calculates a time correlation function of the constituent component C, based on a calculation result of the total electric dipole moment, and thereafter approximates a calculation result of the time correlation function with an exponential function. Further, the calculator 10 calculates the individually calculated DRS signal S1 of the constituent component C by Fourier transforming an approximation result of the time correlation function.

When the electrolytic solution includes two or more constituent components C, the individually calculated DRS signal S1 is calculated for each of the two or more constituent components C. Accordingly, multiple individually calculated DRS signals S1 are obtained. Thus, as described above, the calculated DRS signal S2 of the electrolytic solution is calculated by adding up the multiple individually calculated DRS signals S1.

Hereinafter, a calculation procedure of the individually calculated DRS signal S1 according to the first embodiment is referred to as “Calculation procedure 1” in order to distinguish it from a calculation procedure of the individually calculated DRS signal S1 according to a second embodiment described later.

The functions of the calculator 10 described above will be specifically described in detail when an operation (an analysis procedure) of the analysis apparatus 100 is described later.

After calculating the individually calculated DRS signal S1 and the calculated DRS signal S2, the calculator 10 outputs data D1 to the comparison device 30. The data D1 includes information including, without limitation, the individually calculated DRS signal S1, the calculated DRS signal S2, and the physical property value P.

The measurer 20 measures the DRS signal of the electrolytic solution by analyzing the electrolytic solution by dielectric relaxation spectroscopy. This DRS signal is the DRS signal (a third dielectric relaxation spectrum signal) of the electrolytic solution measured by the measurer 20, and is hereinafter referred to as the “measured DRS signal S3”. The dielectric relaxation spectroscopy is a useful analysis method that makes it possible to find out an ion transport property of the electrolytic solution, and mobility of each of the constituent components C that influences the ion transport property.

Note that after measuring the measured DRS signal S3, the measurer 20 corrects the measured DRS signal S3. In this case, it is preferable that the measurer 20 correct the measured DRS signal S3 by removing, from the measured DRS signal S3, an error derived from ionic conductivity of the electrolytic solution. One reason for this is that this removes the error derived from a physical property other than the mobility of each of the constituent components C, and thus improves measurement accuracy of the measured DRS signal S3.

Here, the measurer 20 includes a dielectric spectroscopy unit and a correction unit, which are not illustrated.

The dielectric spectroscopy unit measures the measured DRS signal S3 by irradiating the electrolytic solution with an electromagnetic wave and receiving a response wave from the electrolytic solution. A method of measuring the measured DRS signal S3 is not particularly limited. For example, the method of measuring the measured DRS signal S3 is preferably a reflection-transmission method (an S-parameter method). One reason for this is that this makes it possible to highly accurately measure the measured DRS signal S3 of a liquid (in this case, the electrolytic solution). After measuring the measured DRS signal S3, the dielectric spectroscopy unit outputs a measurement result of the measured DRS signal S3 to the correction unit.

More specifically, the dielectric spectroscopy unit includes a measurement cell, a transmitter, a receiver, a dielectric spectroscopy sensor, and a computing device.

The measurement cell is a container that is to contain the electrolytic solution. It is preferable that the electrolytic solution contained inside the measurement cell do not include any bubble. In addition, it is preferable that an amount of the electrolytic solution to be contained in the measurement cell be an appropriate amount that allows for contact between the electrolytic solution and a probe described later.

The transmitter irradiates the electrolytic solution contained inside the measurement cell, with an electromagnetic wave such as a microwave. A frequency of the microwave is not particularly limited, and is, for example, within a range from 100 MHz to 100 GHz both inclusive.

The receiver receives the response wave from the measurement cell via the dielectric spectroscopic sensor. The response wave includes the electromagnetic wave reflected by the electrolytic solution and the electromagnetic wave transmitted through the electrolytic solution.

The computing device calculates the measured DRS signal S3, based on, for example but not limited to, an amplitude and a phase of the response wave received by the receiver. Specific examples of the computing device include a microprocessor.

The dielectric spectroscopy unit is not particularly limited in specific configuration. For example, the dielectric spectroscopy unit that measures the measured DRS signal S3 by the reflection-transmission method is a vector network analyzer (VNA) or the like to which an open-ended probe is coupled via a microwave coaxial cable. The probe is coupled to the measurement cell via two ports (i.e., a first port and a second port). The microwave coaxial cable is a coaxial cable corresponding to a frequency band of the microwave with which the electrolytic solution is to be irradiated.

The dielectric spectroscopy unit that uses the reflection-transmission method calculates the measured DRS signal S3, based on reflection coefficients S11 and S22 each defined as reflected wave/incident wave. The reflection coefficient S11 is a reflection coefficient corresponding to the first port, and the reflection coefficient S22 is a reflection coefficient corresponding to the second port.

The correction unit corrects the measurement result of the measured DRS signal S3 measured by the dielectric spectroscopy unit. A correction method to be used by the correction unit is not particularly limited, and may be chosen as desired. In particular, in order to focus on a rotational part of a molecular motion of each of the constituent components C, the correction unit preferably removes the error derived from the ionic conductivity (an ionic conductivity rate) included in the measurement result of the measured DRS signal S3 as described above.

Specifically, when receiving the measured DRS signal S3 from the dielectric spectroscopy unit, the correction unit performs fitting, with what is called a Debye relaxation function, of a dielectric constant imaginary part of the measured DRS signal S3 in a frequency band of 500 MHz or higher, out of the dielectric constant imaginary part of the measured DRS signal S3. In general, the frequency band of 500 MHz or higher is less influenced by the error derived from the ionic conductivity of the electrolytic solution. The correction unit thus extrapolates a result of the fitting to a low frequency side to correct the measured DRS signal S3 in a frequency band of lower than 500 MHz.

Note that a signal, out of the measured DRS signal S3, corresponding to the error removed by the correction unit represents the physical property of each of the constituent components C derived from an ion conduction phenomenon as described above, and such a physical property is information on the mobility (the ion transport property) other than a rotational motion. Therefore, the signal, out of the measured DRS signal S3, that has been removed by the correction unit may be used separately as the information on the mobility other than the rotational motion of each of the constituent components C, to find out the physical property of the electrolytic solution.

Specific examples of the correction unit include a microprocessor.

Here, the measurer 20 includes the correction unit in order to correct the measurement result of the measured DRS signal S3, as described above. However, when the measurement result of the measured DRS signal S3 does not need to be corrected, the measurer 20 does not have to include the correction unit.

The functions of the measurer 20 described above will be specifically described in detail when the operation (the analysis procedure) of the analysis apparatus 100 is described later.

After measuring the measured DRS signal S3, the measurer 20 outputs data D2 to the comparison device 30. The data D2 includes information including, without limitation, the measured DRS signal S3.

The comparison device 30 compares the calculated DRS signal S2 and the measured DRS signal S3 with each other, based on the data D1 received from the calculator 10 and the data D2 received from the measurer 20. The comparison device 30 thus assigns the measured DRS signal S3, based on the individually calculated DRS signal S1, which is a constituent part of the calculated DRS signal S2, and based on a result of the comparison between the calculated DRS signal S2 and the measured DRS signal S3. Specific examples of the comparison device 30 include a microprocessor.

Specifically, the comparison device 30 confirms that the calculated DRS signal S2 and the measured DRS signal S3 qualitatively coincide with each other. In this case, the comparison device 30 compares a spectrum shape of the calculated DRS signal S2 and a spectrum shape of the measured DRS signal S3 with each other in order to confirm that the calculated DRS signal S2 and the measured DRS signal S3 qualitatively coincide with each other. When the comparison device 30 thus confirms that the spectrum shape of the calculated DRS signal S2 and the spectrum shape of the measured DRS signal S3 qualitatively coincide with each other, the comparison device 30 determines that the calculated DRS signal S2 and the measured DRS signal S3 qualitatively coincide with each other.

The comparison device 30 includes a computing device that performs a comparison process between the calculated DRS signal S2 and the measured DRS signal S3 by using an image analysis process. Specific examples of the computing device include a microprocessor. A method of the comparison process is not particularly limited as long as it is software configured to execute the comparison process. In this case, conditions of the comparison process may be set as desired.

When the measurer 20 has corrected the measured DRS signal S3, the comparison device 30 compares the calculated DRS signal S2 and a correction result of the measured DRS signal S3 with each other to assign the calculated DRS signal S2 with respect to the measured DRS signal S3.

Here, the measured DRS signal S3 measured by the measurer 20 with use of the electrolytic solution is important information in examining the physical property (mobility in molecular level) of the electrolytic solution; however, it is difficult to find out details of the physical property of the electrolytic solution only based on the measured DRS signal S3. One reason for this is that when the electrolytic solution includes two or more constituent components C, the measured DRS signal S3 of the electrolytic solution is a signal in which the respective DRS signals that are to be measured for the constituent components C are added up, but it is very difficult to measure the DRS signal for each of the constituent components C by the measurer 20. Thus, it is possible to find out the physical property of the electrolytic solution as a whole, based on the measured DRS signal S3; however, it is very difficult to find out the physical property of each of the constituent components C that influences the physical property of the electrolytic solution as a whole, based on the measured DRS signal S3.

To address this, the comparison device 30 acquires the calculated DRS signal S2 and the measured DRS signal S3, and thereafter confirms that the calculated DRS signal S2 and the measured DRS signal S3 qualitatively coincide with each other, in order to allow not only the physical property of the electrolytic solution as a whole but also the physical property of each of the constituent components C to be found out.

The measured DRS signal S3 measured by the measurer 20 is one DRS signal measured regarding the electrolytic solution, as described above. Meanwhile, the calculated DRS signal S2 calculated by the calculator 10 is the DRS signal in which the respective individually calculated DRS signals S1 calculated for the constituent components C are added up, as described above. Thus, the calculated DRS signal S2 calculated by the calculator 10 is one DRS signal (the calculated DRS signal S2) calculated regarding the electrolytic solution, and includes the respective DRS signals (the respective individually calculated DRS signals S1) calculated for the constituent components C.

For the above-described reasons, if qualitative coincidence between the calculated DRS signal S2 and the measured DRS signal S3 is confirmed by the comparison device 30, reliability of the calculated DRS signal S2 with respect to the measured DRS signal S3, in other words, validity of the MD calculation, is guaranteed. Accordingly, reliability of the individually calculated DRS signals S1 included in the calculated DRS signal S2 is also guaranteed. This technically guarantees to employ the individually calculated DRS signal S1 as information representing the physical property of corresponding one of the constituent components C. It is therefore possible to assign the measured DRS signal S3, based on the individually calculated DRS signals S1, even if it is not possible to measure the DRS signal for each of the constituent components C.

The functions of the comparison device 30 described above will be specifically described in detail when the operation (the analysis procedure) of the analysis apparatus 100 is described later.

After performing the comparison and assignment based on the calculated DRS signal S2 and the measured DRS signal S3, the comparison device 30 outputs data D3 to an outside. The data D3 includes information including, without limitation, the individually calculated DRS signal S1, the calculated DRS signal S2, the measured DRS signal S3, and the physical property value P.

Note that the analysis apparatus 100 may further include any one or more of other components according to an embodiment.

Specific examples of the other components include a display, a storage, and a power supply. The display displays, for example but not limited to, the calculation result obtained by the calculator 10, the measurement result obtained by the measurer 20, and a comparison result (an assignment result) obtained by the comparison device 30. The storage holds, for example but not limited to, the series of calculation results obtained in the analysis apparatus 100. The power supply is an electric power source of the analysis apparatus 100.

The electrolytic solution to be analyzed by the analysis apparatus 100 includes a solvent and an electrolyte salt, as described above. Note that the electrolytic solution may further include any one or more of various additives.

The solvent includes any one or more of media in which the electrolyte salt is to be dispersed or dissolved. The solvent may be an aqueous solvent or a non-aqueous solvent.

The non-aqueous solvent is not particularly limited in kind. For example, the non-aqueous solvent includes any one or more of materials including, without limitation, a cyclic carbonic acid ester, a chain carbonic acid ester, and a chain carboxylic acid ester.

Specific examples of the cyclic carbonic acid ester include ethylene carbonate and propylene carbonate. Specific examples of the chain carbonic acid ester include dimethyl carbonate, diethyl carbonate, and ethyl methyl carbonate. Specific examples of the chain carboxylic acid ester include ethyl propionate and propyl propionate.

The electrolyte salt is a solute to be dispersed or dissolved in the solvent, and includes any one or more of metal salts. The one or more metal salts are not particularly limited in kind. For example, the one or more metal salts include any one or more of lithium salts including, without limitation, lithium hexafluorophosphate (LiPF₆), lithium tetrafluoroborate (LiBF₄), lithium bis(fluorosulfonyl)imide (LiN(FSO₂)₂), and lithium bis(trifluoromethanesulfonyl)imide (LiN(CF₃SO₂)₂).

The one or more constituent components C include any one or more kinds selected from neutral molecules and ion pairs, as described above.

The neutral molecule is an electrically neutral molecule, and is a component that is chemically stable over time. The neutral molecule is not particularly limited in kind. For example, the neutral molecule is a molecule of the solvent.

The ion pair is an electrically bonded form of a cation and an anion. The ion pair is not particularly limited in kind. For example, the ion pair is a contact ion pair (CIP), a solvent ion pair (SIP), or a solvent-separated ion pair (SSIP), and may be any other electrically bonded form.

Ions forming the ion pair are not particularly limited in kind as long as the ions include two or more kinds of ions, as described above. Accordingly, only one kind of cation may form the ion pair, or two or more kinds of cations may form the ion pair. Similarly, only one kind of anion may form the ion pair, or two or more kinds of anions may form the ion pair.

Thus, the ion pair described here encompasses not only an electrically bonded form of one kind of cation and one kind of anion, but also an electrically bonded form of two or more kinds of cations and two or more kinds of anions (i.e., what is called an ionically bonded form). The ionically bonded form encompasses a multimer such as tetramer.

In particular, unlike the neutral molecule that is a static component electrically stable in the electrolytic solution, the ion pair is a dynamic component that alternately and repeatedly undergoes formation (gathering) and disappearing (dispersing) over time in the electrolytic solution. Therefore, the analysis apparatus 100 makes it possible not only to examine the physical property of the neutral molecule, but also to examine the physical property of the ion pair by analyzing the electrolytic solution with the calculator 10, the measurer 20, and the comparison device 30.

Although it has already been possible to examine the physical property of the neutral molecule, it has been very difficult to examine the physical property of the ion pair. For such a reason, the analysis of the electrolytic solution by the analysis apparatus 100 is very important in that the analysis allows for examination of the physical property of the ion pair, which has been a difficult task, in particular.

Next, a description is given of an analysis method in which the analysis apparatus 100 is used. The analysis method described here is what is called the operation (the analysis procedure) of the analysis apparatus 100.

For easier understanding, the following description deals with an example case where the electrolytic solution includes two or more constituent components C (multiple neutral molecules m and multiple ion pairs x).

When the analysis apparatus 100 analyzes the electrolytic solution, first, the calculator 10 calculates each of the individually calculated DRS signals S1, the calculated DRS signal S2, and the physical property values P by performing the MD calculation regarding the electrolytic solution, in accordance with a procedure described below.

Specifically, first, the MD calculation regarding the electrolytic solution is performed.

In this case, the MD calculation is executed with use of MD calculation software, by employing the two or more constituent components C that are already known to be included in the electrolytic solution. The dynamical behavior of the series of atoms included in each of the constituent components C is calculated by such an MD calculation.

Note that when the two or more constituent components C included in the electrolytic solution are unknown, two or more constituent components C that are assumed to be included in the electrolytic solution may be employed.

The method (including the kind of the force field) of the MD calculation is not particularly limited as long as it is software configured to execute the MD calculation, as described above. In this case, the conditions of the MD calculation may be set as desired.

Thereafter, in order to calculate the individually calculated DRS signals S1, a calculation process described below is performed based on a calculation result obtained by the MD calculation.

Specifically, a total electric dipole moment of each of the constituent components C is calculated.

In this case, information on coordinates and charge of each of the atoms at each of time points is read based on a trajectory included in the calculation result obtained by the MD calculation. Thus, an individual electric dipole moment of an i-th neutral molecule m among Nₘ-number of neutral molecules m included in a calculation cell of the MD calculation (where i=1, 2, 3, . . . , Nₘ) is calculated based on a calculation expression represented by Expression (1).

$${d}_{m , i} = {\sum }_{j} {q}_{j} {x}_{m , ij} \qquad ( 1 )$$

where:
d_{m,i} is an individual electric dipole moment of the neutral molecule m;
j is an index of the atom included in the i-th neutral molecule m;
qⱼ is charge of the atom j; and
x_{m,ij} is coordinates of the atom j, and thus is relative coordinates with respect to center of gravity of the i-th molecule.

Thereafter, a total electric dipole moment of the neutral molecule m is calculated based on a calculation expression represented by Expression (2).

$${M}_{m} = {\sum }_{i} {d}_{m , i} \qquad ( 2 )$$

where Mₘ is the total electric dipole moment of the neutral molecule m.

Lastly, a total electric dipole moment of the ion pair x is calculated based on a calculation expression represented by Expression (3). A calculation procedure of dxi is similar to the calculation procedure based on Expression (1).

$${M}_{x} {\sum }_{i} = {d}_{x , i}^{′} \qquad ( 3 )$$

$${d}_{x , i}^{′} = \{ \begin{matrix}{d}_{x , i} & if {r}_{Li - x} satisfies specific condition \\ 0 & others\end{matrix}$$

Here, when the total electric dipole moment of the ion pair x (CIP) is to be calculated, the electric dipole moment is calculated only if the following condition is satisfied: a distance r_{W-X} between center of gravity W of the cation and center of gravity X of the anion is a predetermined distance or less. For example, when the electrolyte salt is lithium hexafluorophosphate (LiPF₆), the electric dipole moment is calculated only if the following condition is satisfied: the distance r_{W-X} is 0.425 nₘ (=4.25 Å) or less.

Note that the above-described threshold “0.425 nm” of the distance r_{W-X} is, when the electrolyte salt is lithium hexafluorophosphate (LiPF₆), a value that corresponds to a position at which a radial distribution function of a phosphorus atom (P) centered on a lithium atom has a first dip. Such a value is appropriately determined depending on the kind of the cation and the kind of the anion. Note that although the ion pair x based on a nearest neighbor position between the lithium atom and the anion is set to the CIP, it is possible to perform a similar analysis on the ion pair x other than the CIP by determining, for example, a next-nearest neighbor position, based on the radial distribution function.

Thereafter, the time correlation function of each of the constituent components C is calculated based on the total dipole moment.

In this case, a time correlation function of the total electric dipole moment of the neutral molecule m is calculated based on a calculation expression represented by Expression (4).

$${C}_{m , total} ( t ) = \frac{〈 {M}_{m} ( t ) \cdot {M}_{m} ( 0 ) 〉 - {〈 {M}_{m} ( 0 ) 〉}^{2}}{〈 {M}_{m} ( 0 ) \cdot {M}_{m} ( 0 ) 〉 - {〈 {M}_{m} ( 0 ) 〉}^{2}} \qquad ( 4 )$$

where C_{m,total} (t) is the time correlation function of the total electric dipole moment of the neutral molecule m.

In addition, a time correlation function of the total electric dipole moment of the ion pair x is calculated based on a calculation expression represented by Expression (5).

$${C}_{x , total} ( t ) = \frac{〈 {M}_{x} ( t ) \cdot {M}_{x} ( 0 ) 〉 - {〈 {M}_{x} ( 0 ) 〉}^{2}}{〈 {M}_{x} ( 0 ) \cdot {M}_{x} ( 0 ) 〉 - {〈 {M}_{x} ( 0 ) 〉}^{2}} \qquad ( 5 )$$

where C_{x,total} (t) is the time correlation function of the total electric dipole moment of the ion pair X.

Thereafter, the time correlation function is approximated with an exponential function.

In this case, the time correlation function of the neutral molecule m is fitted by a least squares method. This removes a noise (a variation error) from the time correlation function, and thus suppresses an influence of, for example, a calculation error in Fourier transform to be described later.

In addition, the time correlation function of the ion pair x is fitted by the least squares method. This removes a noise (a variation error) from the time correlation function, and thus, as described above, suppresses an influence of, for example, a calculation error in Fourier transform to be described later.

Thereafter, each of the individually calculated DRS signals S1 and the calculated DRS signal S2 is calculated by Fourier transforming an approximation result of the time correlation function.

Specifically, a relaxation strength Δεₘ of the neutral molecule m is calculated based on a calculation expression represented by Expression (8). In addition, the approximation result of the time correlation function of the neutral molecule m is Fourier transformed with the relaxation strength Δεₘ. A dielectric constant real part is thus calculated based on a calculation expression represented by Expression (6), and a dielectric constant imaginary part is thus calculated based on a calculation expression represented by Expression (7). The individually calculated DRS signal S1 including the dielectric constant real part and the dielectric constant imaginary part is thus calculated for the neutral molecule m.

$${ε}_{m}^{′} ( ω ) = ( 1 - ω {\int }_{0}^{∞} {C}_{m , total} ( t ) sin ω t dt ) Δ {ε}_{m} \qquad ( 6 )$$

where:
ε′ₘ(ω) is the dielectric constant real part of the neutral molecule m; and
ω=2πν.

$${ε}_{m}^{″} ( ω ) = ( ω {\int }_{0}^{∞} {C}_{m , total} ( t ) cos ω t dt ) Δ {ε}_{m} \qquad ( 7 )$$

where:
ε″ₘ(ω) is the dielectric constant imaginary part of the neutral molecule m; and
ω=2πν.

$$Δ {ε}_{{m}^{=}} \frac{4 π}{3 {VK}_{B} T} ( 〈 {M}_{m}^{2} 〉 - {〈 {M}_{m} 〉}^{2} ) \qquad ( 8 )$$

where:
Δεₘ is the relaxation strength of the neutral molecule m;
V is a volume;
K_{B} is a Boltzmann constant; and
T is a temperature.

In addition, a relaxation strength Δεₓ of the ion pair x is calculated based on a calculation expression represented by Expression (11). In addition, an approximation result of the time correlation function of the ion pair x is Fourier transformed with the relaxation strength Δεₓ. A dielectric constant real part is thus calculated based on a calculation expression represented by Expression (9), and a dielectric constant imaginary part is thus calculated based on a calculation expression represented by Expression (10). The individually calculated DRS signal S1 including the dielectric constant real part and the dielectric constant imaginary part is thus calculated for the ion pair x.

$${ε}_{x}^{′} ( ω ) = ( 1 - ω {\int }_{0}^{∞} {C}_{x , total} ( t ) sin ω t dt ) Δ {ε}_{x} \qquad ( 9 )$$

where:
ε′ₓ(ω) is the dielectric constant real part of the ion pair x; and
ω=2πν.

$${ε}_{x}^{′′} ( ω ) = ( ω {\int }_{0}^{∞} {C}_{x , total} ( t ) cos ω t dt ) {Δ}_{{ε}_{x}} \qquad ( 10 )$$

where:
ε″ₓ(ω) is the dielectric constant imaginary part of the ion pair x; and
ω=2πν.

$${Δ}_{{ε}_{x}} = A \frac{4 π}{3 {VK}_{B} T} ( 〈 {M}_{x}^{2} 〉 - {〈 {M}_{x} 〉}^{2} ) \qquad ( 11 )$$

where:
Δεₓ is the relaxation strength of the ion pair x;
V is a volume;
K_{B} is the Boltzmann constant;
T is a temperature; and
A is a scale factor.

As indicated in Expression (11), the scale factor A is used when the relaxation strength Δεₓ of the ion pair x is to be calculated. If the total electric dipole moment of the ion pair x is calculated without taking into account an influence of the solvent present around the ion pair x, accuracy of the individually calculated DRS signal S1 to be eventually calculated can decrease due to an error. Therefore, the appropriate scale factor A is used in order to effectively introduce a shielding effect against the solvent around the ion pair x. The scale factor A is not particularly limited in value. For example, the scale factor A is 0.25.

The calculated DRS signal S2 of the electrolytic solution is thus calculated by adding up the individually calculated DRS signal S1 of the neutral molecule m and the individually calculated DRS signal S1 of the ion pair x.

Thereafter, the physical property value P unique to each of the constituent components C is calculated based on the individually calculated DRS signal S1 and the calculated DRS signal S2.

Here, a description is given of an example case where the relaxation strengths Δεₘ and Δεₓ, characteristic times τₘ and τₓ, concentrations nₘ and nₓ, static dielectric constants εₘ^{sta} and εₓ^{sta}, and a salt dissociation degree α are each calculated as the physical property value P.

When the relaxation strength Δεₘ of the neutral molecule m is to be calculated, the relaxation strength Δεₘ is calculated based on the calculation expression represented by Expression (8), as described above. When the relaxation strength Δεₓ of the ion pair x is to be calculated, the relaxation strength Δεₓ is calculated based on the calculation expression represented by Expression (11) as described above.

When the characteristic time τₘ of the neutral molecule m is to be calculated, the characteristic time τₘ is calculated based on a calculation expression represented by Expression (12), in which a frequency at a peak position of the individually calculated DRS signal S1 (the dielectric constant imaginary part) of the neutral molecule m is set to a specific frequency νₘ. The characteristic time τₘ is a reciprocal of the specific frequency νₘ.

$${τ}_{{m}^{=}} 1 / 2 π {ν}_{m} … \qquad ( 12 )$$

Further, when the characteristic time τₓ of the ion pair x is to be calculated, the characteristic time τₓ is calculated based on a calculation expression represented by Expression (13), in which a frequency at a peak position of the individually calculated DRS signal S1 (the dielectric constant imaginary part) of the ion pair x is set to a specific frequency νₓ. The characteristic time τₓ is a reciprocal of the specific frequency νₓ.

$${τ}_{{x}^{=}} 1 / 2 π {ν}_{x} \qquad ( 13 )$$

When the concentration nₘ of the neutral molecule m is to be calculated, the concentration nₘ is calculated based on the number Nₘ of the neutral molecules m included in the calculation cell of the MD calculation and the volume V of the calculation cell of the MD calculation, and based on the following calculation expression: nₘ=Nₘ/V.

In addition, when the concentration nₓ of the ion pair x is to be calculated, the concentration nₓ is calculated based on an average number <Nₓ> of the ion pairs x included in the calculation cell of the MD calculation and the volume V of the calculation cell of the MD calculation, and based on the following calculation expression: nₓ=<Nₓ>/V.

When the salt dissociation degree α is to be calculated, the salt dissociation degree α is calculated based on a total number N_{cat} of cations included in the calculation cell of the MD calculation and an average number <N_{cat,free}> of cations that are not near the anions, among the cations, and based on the following calculation expression: α=<N_{cat,free}>/N_{cat}.

When the static dielectric constant εₘ^{sta} of the neutral molecule m is to be calculated, the dielectric constant is calculated based on the individually calculated DRS signal S1 (the dielectric constant real part) of the neutral molecule m where ω→0 (or ν→0), and the calculated value of the dielectric constant is regarded as the static dielectric constant εₘ^{sta}.

In addition, when the static dielectric constant εₓ^{sta} of the ion pair x is to be calculated, the dielectric constant is calculated based on the individually calculated DRS signal S1 (the dielectric constant real part) of the ion pair x where ω→0 (or ν→0), and the calculated value of the dielectric constant is regarded as the static dielectric constant εₓ^{sta}.

Lastly, the data D1 is outputted to the comparison device 30. Details of the data D1 are as described above.

Thereafter, the measured DRS signal S3 of the electrolytic solution is measured by causing the measurer 20 to analyze the electrolytic solution by the dielectric relaxation spectroscopy in accordance with the following procedure.

Specifically, first, the measured DRS signal S3 of the electrolytic solution is measured based on an analysis result of the electrolytic solution obtained by the dielectric relaxation spectroscopy.

Thereafter, the measured DRS signal S3 is corrected. In this case, the error derived from the ionic conductivity of the electrolytic solution is removed from the measured DRS signal S3 by fitting the measured DRS signal S3 based on the Debye relaxation function as described above.

Lastly, the data D2 is outputted to the comparison device 30. Details of the data D2 are as described above.

Lastly, the measured DRS signal S3 is assigned based on the individually calculated DRS signals S1, which are each a constituent part of the calculated DRS signal S2, by causing the comparison device 30 to compare the calculated DRS signal S2 and the measured DRS signal S3 with each other and to confirm that the calculated DRS signal S2 and the measured DRS signal S3 qualitatively coincide with each other.

Specifically, first, it is confirmed whether the calculated DRS signal S2 and the measured DRS signal S3 qualitatively coincide with each other by comparing the calculated DRS signal S2 and the measured DRS signal S3 with each other.

In this case, the spectrum shape of the calculated DRS signal S2 and the spectrum shape of the measured DRS signal S3 are compared with each other in terms of whether the spectrum shape of the calculated DRS signal S2 and the spectrum shape of the measured DRS signal S3 qualitatively coincide with each other.

Examples of comparison points in comparing the spectrum shape of the calculated DRS signal S2 and the spectrum shape of the measured DRS signal S3 with each other are as described below.
(1) A value of the frequency at the peak position of the dielectric constant imaginary part
(2) A value of the intensity at the peak position of the dielectric constant imaginary part
(3) A value of the static dielectric constant
(4) A tendency of a change in each of the series of values described in (1) to (3) above, when the concentration of the electrolytic solution is changed

Thereafter, the measured DRS signal S3 is assigned based on the individually calculated DRS signals S1.

In this case, when it has been confirmed that the calculated DRS signal S2 and the measured DRS signal S3 qualitatively coincide with each other, it is determined that the reliability of the calculated DRS signal S2 has been guaranteed, and it is thus determined that the measured DRS signal S3 has been assigned based on the individually calculated DRS signals S1.

In this case, because the reliability of the calculated DRS signal S2 is guaranteed, reliability of the multiple individually calculated DRS signals S1 included in the calculated DRS signal S2 is also guaranteed. Therefore, it is technically and logically (in terms of accuracy) acceptable to assume that decomposition of the measured DRS signal S3 into respective signals corresponding to the constituent components C should result in acquisition of the multiple individually calculated DRS signals S1.

Lastly, the data D3 is outputted to the outside. Details of the data D3 are as described above.

Note that the analysis apparatus 100 may store the data D3 inside the analysis apparatus 100 rather than output the data D3 to the outside. Needless to say, the analysis apparatus 100 may store the data D3 inside the analysis apparatus 100 and also output the data D3 to the outside.

According to the analysis apparatus 100 of the first embodiment, the analysis apparatus 100 includes the calculator 10, the measurer 20, and the comparison device 30. The calculator 10 calculates each of the individually calculated DRS signal S1 and the calculated DRS signal S2 by the MD calculation regarding the electrolytic solution, and also calculates the physical property value P. The measurer 20 measures the measured DRS signal S3 of the electrolytic solution by analyzing the electrolytic solution by the dielectric relaxation spectroscopy. The comparison device 30 assigns the measured DRS signal S3, based on the individually calculated DRS signal S1, which is a constituent part of the calculated DRS signal S2, by comparing the calculated DRS signal S2 and the measured DRS signal S3 with each other.

In particular, the calculator 10 calculates the individually calculated DRS signal S1 in accordance with Calculation procedure 1. Specifically, the calculator 10 calculates the total electric dipole moment of the constituent component C, calculates the time correlation function of the constituent component C, approximates the time correlation function with an exponential function, and Fourier transforms the approximation result of the time correlation function to calculate the individually calculated DRS signal S1 of the constituent component C.

In this case, the comparison device 30 compares the calculated DRS signal S2 of the electrolytic solution calculated by the calculator 10 based on the MD calculation, and the measured DRS signal S3 of the electrolytic solution measured by the measurer 20 by the dielectric relaxation spectroscopy with each other. If it is thus confirmed that the calculated DRS signal S2 and the measured DRS signal S3 qualitatively coincide each other, the reliability of the calculated DRS signal S2 with respect to the measured DRS signal S3 is guaranteed. Accordingly, the reliability of the multiple individually calculated DRS signals S1 included in the calculated DRS signal S2 is also guaranteed. It is thus possible to assign the measured DRS signal S3, based on the individually calculated DRS signals S1, which are each a constituent part of the calculated DRS signal S2.

Thus, the physical property of the neutral molecule m is found out based on the individually calculated DRS signal S1 of the neutral molecule m, and in addition, the physical property of the ion pair x is also found out based on the individually calculated DRS signal S1 of the ion pair x. This makes it possible to freely design a configuration of an electrolytic solution having desired performance in terms of a property such as the ion transport property by taking into account not only the physical property of the neutral molecule m but also the physical property of the ion pair x.

Accordingly, when a configuration of a new electrolytic solution is to be designed, the configuration of the electrolytic solution having the desired performance is designed without actually measuring the physical property of the neutral molecule m and the physical property of the ion pair x as described above. This makes it possible to easily and highly accurately analyze the physical property of the electrolytic solution.

In this case, in particular, it is possible, as described above, to find out the physical property of the ion pair, which has been difficult. In addition, because it is possible to find out the physical property of the constituent component C, simply based on the calculated DRS signal S2 (the individually calculated DRS signal S1), it is not necessary to prepare a calibration model such as a calibration curve in advance, and it is not necessary to standardize the intensity of the DRS signal either. This makes it possible to more easily analyze the physical property of the electrolytic solution in detail, and thus makes it possible to more highly accurately design the configuration of the electrolytic solution having the desired performance.

In particular, the electrolytic solution may include the solvent and the electrolyte salt, and the constituent component C may include one or more kinds selected from the neutral molecules and the ion pairs. This makes it possible to analyze not only the physical property of the neutral molecule but also the physical property of the ion pair, and thus makes it possible to more highly accurately analyze the physical property of the electrolytic solution. Accordingly, it is possible to achieve higher effects.

Further, the physical property value P may include any one or more of the relaxation strength, the characteristic time, the static dielectric constant, the concentration, or the salt dissociation degree. This makes it possible to more highly accurately analyze various physical properties regarding the electrolytic solution. Accordingly, it is possible to achieve higher effects.

Further, to calculate the individually calculated DRS signal S1, the calculator 10 may calculate the total electric dipole moment of the constituent component C, calculate the time correlation function of the constituent component C, approximate the time correlation function with an exponential function, and calculate the individually calculated DRS signal S1 by Fourier transforming the approximated time correlation function. This makes it possible to highly accurately calculate the individually calculated DRS signal S1 of the constituent component C, based on the calculation process. Accordingly, it is possible to achieve higher effects.

Further, the constituent component C may include two or more kinds selected from the neutral molecules and the ion pairs. The calculator 10 may calculate the calculated DRS signal S2 by calculating the individually calculated DRS signal S1 of each of the two or more constituent components C, and thereafter adding up the individually calculated DRS signals S1. This allows for the calculation of the calculated DRS signal S2 even when two or more constituent components C are used. Accordingly, it is possible to achieve higher effects.

Further, the measurer 20 may correct the measured DRS signal S3 by removing, from the measured DRS signal S3, the error derived from the ionic conductivity of the electrolytic solution. In addition, the comparison device 30 may compare the calculated DRS signal S2 and the correction result of the measured DRS signal S3 with each other. This improves accuracy of the comparison, and thus improves accuracy of the assignment. This makes it possible to more highly accurately analyze the physical property of the electrolytic solution. Accordingly, it is possible to achieve higher effects.

In addition, according to the analysis method of the first embodiment: each of the individually calculated DRS signal S1 and the calculated DRS signal S2 is calculated based on the MD calculation regarding the electrolytic solution; the measured DRS signal S3 of the electrolytic solution is measured by the dielectric relaxation spectroscopy; the calculated DRS signal S2 and the measured DRS signal S3 are compared with each other; the measured DRS signal S3 is assigned based on the individually calculated DRS signal S1, which is a constituent part of the calculated DRS signal S2; and the physical property value P regarding the electrolytic solution is calculated. This makes it possible to easily and highly accurately analyze the physical property of the electrolytic solution, for the reasons described above.

Other workings and effects regarding the analysis method are similar to those regarding the analysis apparatus 100.

Next, a description is given of an analysis apparatus and an analysis method according to a second embodiment of the present technology.

The analysis apparatus 100 according to the second embodiment has a configuration similar to that of the analysis apparatus 100 according to the first embodiment, except that the calculation procedure of the individually calculated DRS signal S1 to be performed by the calculator 10 is different as described below. Note that details of each of the electrolytic solution, the constituent component C, and the physical property value P are as described above.

Here, a description is given of the configuration of the analysis apparatus 100 according to the second embodiment with reference to FIG. 1 that has already been described.

The configuration of the analysis apparatus 100 according to the second embodiment is similar to that of the analysis apparatus 100 according to the first embodiment, except for the following points.

Here, the calculator 10 sequentially performs calculation processes described below in order to calculate the individually calculated DRS signal S1. That is, the calculator 10 calculates an individual electric dipole moment of the constituent component C, based on the calculation result obtained by the MD calculation. Further, the calculator 10 calculates a time correlation function of the constituent component C, based on the individual electric dipole moment, and thereafter calculates a rotational correlation time of the constituent component C by approximating the time correlation function with an exponential function. Further, the calculator 10 calculates the individually calculated DRS signal S1 of the constituent component C, based on the rotational correlation time.

Hereinafter, the calculation procedure of the individually calculated DRS signal S1 according to the second embodiment is referred to as “Calculation procedure 2”. Thus, the configuration of the analysis apparatus 100 according to the second embodiment is similar to that of the analysis apparatus 100 according to the first embodiment, except that the calculator 10 calculates the individually calculated DRS signal S1 in accordance with Calculation procedure 2 instead of Calculation procedure 1.

The functions of the calculator 10 described above will be specifically described in detail when an operation (an analysis procedure) of the analysis apparatus 100 is described later.

A description is given of an analysis method in which the analysis apparatus 100 according to the second embodiment is used. The analysis method described below is the operation (the analysis procedure) of the analysis apparatus 100, as described above.

A procedure of the analysis method according to the second embodiment is similar to that in the first embodiment, except for the following points.

In order to calculate the individually calculated DRS signal S1, the calculator 10 performs a calculation process described below based on the calculation result obtained by the MD calculation.

Specifically, first, the individual electric dipole moment of each of the constituent components C is calculated.

In this case, coordinates and charge of each of atoms at each of time points are read based on a trajectory included in the calculation result obtained by the MD calculation. An individual electric dipole moment of an i-th neutral molecule m among the Nₘ-number of neutral molecules m is calculated for each of the time points, and an individual electric dipole moment of an i-th ion pair x among Nₓ-number of ion pairs x is calculated for each of the time points.

Thereafter, a rotational correlation function of each of the constituent components C is calculated based on the individual electric dipole moment. The rotational correlation function attenuates exponentially with respect to time.

In this case, the individual dipole moment of the neutral molecule m is standardized. A rotational correlation function of the neutral molecule m is thus calculated for a unit vector having a length of 1, based on a calculation expression represented by Expression (14).

$${C}_{m , r o t} ( t ) = \frac{1}{2} < 3 \frac{1}{{N}_{m}} {\sum }_{i}^{{N}_{m}} {\{ {u}_{m , i} ( t ) \cdot {u}_{m , i} ( 0 ) \}}^{2} - 1 > \qquad ( 14 )$$

where Nₘ is the number of the neutral molecules m.

Further, the individual dipole moment of the ion pair x is standardized. A rotational correlation function of the ion pair x is thus calculated for a unit vector having a length of 1, based on a calculation expression represented by Expression (15).

$${C}_{x , rot} ( t ) = \frac{1}{2} < 3 \frac{1}{{N}_{p a i r}} {\sum }_{i}^{{N}_{pair}} {\{ {u}_{x , i} ( t ) \cdot {u}_{x , i} ( 0 ) \}}^{2} - 1 > \qquad ( 15 )$$

where Nₚₐᵢᵣ is the number of ion pairs for which the individual dipole moment takes a finite value at least once in the trajectory of the MD calculation.

Thereafter, a rotational correlation time of each of the constituent components C is calculated by approximating the rotational correlation function with an exponential function.

In this case, a rotational correlation time of the neutral molecule m is calculated by fitting the rotational correlation function of the neutral molecule m by the least squares method. In addition, a rotational correlation time of the ion pair x is calculated by fitting the rotational correlation function of the ion pair x by the least squares method.

Thus, the characteristic time of the neutral molecule m is calculated based on a calculation expression represented by Expression (16), and a characteristic frequency of the neutral molecule m is calculated based on a calculation expression represented by Expression (17). In addition, the characteristic time of the ion pair x is calculated based on a calculation expression represented by Expression (18), and a characteristic frequency of the ion pair x is calculated based on a calculation expression represented by Expression (19).

$${τ}_{m} = 2 {τ}_{m , rot} \qquad ( 16 )$$

where τₘ is the characteristic time of the neutral molecule m.

$${ν}_{m} 1 / 2 π {τ}_{m} \qquad ( 17 )$$

where νₘ is the characteristic frequency of the neutral molecule m.

$${τ}_{{x}^{=}} 2 {τ}_{x , r o t} \qquad ( 18 )$$

where τₓ is the characteristic time of the ion pair x.

$${ν}_{x} 1 / 2 π {τ}_{x} \qquad ( 19 )$$

where νₓ is the characteristic frequency of the ion pair x.

Thereafter, each of the individually calculated DRS signal S1 and the calculated DRS signal S2 is calculated based on the rotational correlation time.

Specifically, when the individually calculated DRS signal S1 of the neutral molecule m is to be calculated, the dielectric constant real part is calculated by letting a relaxation model for recovery of the DRS signal be a Debye relaxation represented by Expression (20), and the dielectric constant imaginary part is calculated by similarly letting the relaxation model for the recovery of the DRS signal be a Debye relaxation represented by Expression (21). A method of calculating the relaxation strength Δεₘ is as described above. The individually calculated DRS signal S1 including the dielectric constant real part and the dielectric constant imaginary part is thus calculated for the neutral molecule m.

$${ε}_{m}^{′} ( ω ) = Δ {ε}_{m} \frac{1}{1 + {( ω {τ}_{m} )}^{2}} \qquad ( 20 )$$

where:
ε′ₘ(ω) is the dielectric constant real part; and
ω=2πν.

$${ε}_{m}^{′′} ( ω ) = Δ {ε}_{m} \frac{ω {τ}_{m}}{1 + {( ω {τ}_{m} )}^{2}} \qquad ( 21 )$$

where:
ε″ₘ(ω) is the dielectric constant real part; and
ω=2πν.

When the individually calculated DRS signal S1 of the ion pair x is to be calculated, the dielectric constant real part is calculated by letting a relaxation model be a Debye relaxation represented by Expression (22), and the dielectric constant imaginary part is calculated by similarly letting the relaxation model be a Debye relaxation represented by Expression (23). A method of calculating the relaxation strength Δεₓ is as described above. The individually calculated DRS signal S1 including the dielectric constant real part and the dielectric constant imaginary part is thus calculated for the ion pair x.

$${ε}_{x}^{′} ( ω ) = Δ {ε}_{x} \frac{1}{1 + {( ω {τ}_{m} )}^{2}} \qquad ( 22 )$$

where:
ε′ₓ(ω) is the dielectric constant real part; and
ω=2πν.

$${ε}_{x}^{′′} ( ω ) = Δ {ε}_{x} \frac{ω {τ}_{x}}{1 + {( ω {τ}_{x} )}^{2}} \qquad ( 23 )$$

where:
ε″ₓ(ω) is the dielectric constant real part; and
ω=2πν.

Thus, the calculated DRS signal S2 of the electrolytic solution is calculated by adding up the individually calculated DRS signal S1 of the neutral molecule m and the individually calculated DRS signal S1 of the ion pair x.

According to the analysis apparatus 100 of the second embodiment, the analysis apparatus 100 includes the calculator 10, the measurer 20, and the comparison device 30 described above.

In particular, the calculator 10 calculates the individually calculated DRS signal S1 in accordance with Calculation procedure 2 instead of Calculation procedure 1. Specifically, the calculator 10 calculates the individual electric dipole moment of the constituent component C, calculates the rotational correlation function of the constituent component C, approximates the rotational correlation function with an exponential function, calculates the rotational correlation time of the constituent component C, and calculate the individually calculated DRS signal S1 of the constituent component C.

In this case, for a reason similar to that described in relation to the first embodiment, the reliability of the calculated DRS signal S2 (the individually calculated DRS signal S1) with respect to the measured DRS signal S3 is guaranteed. Accordingly, it is possible to find out not only the physical property of the neutral molecule m but also the physical property of the ion pair x. This makes it possible to freely design the configuration of the electrolytic solution having the desired performance in terms of a property such as the ion transport property by taking into account not only the physical property of the neutral molecule m but also the physical property of the ion pair X.

Accordingly, when a configuration of a new electrolytic solution is to be designed, the configuration of the electrolytic solution having the desired performance is designed without actually measuring the physical property of the neutral molecule m and the physical property of the ion pair x. This makes it possible to easily and highly accurately analyze the physical property of the electrolytic solution, as in the first embodiment.

In addition, according to the analysis method of the second embodiment: each of the individually calculated DRS signal S1 and the calculated DRS signal S2 is calculated based on the MD calculation regarding the electrolytic solution; the measured DRS signal S3 of the electrolytic solution is measured by the dielectric relaxation spectroscopy; the measured DRS signal S3 is assigned based on the individually calculated DRS signal S1, which is a constituent part of the calculated DRS signal S2, by comparing the calculated DRS signal S2 and the measured DRS signal S3 with each other; and the physical property value P regarding the electrolytic solution is calculated. This makes it possible to easily and highly accurately analyze the physical property of the electrolytic solution, for the reason described above.

Note that other workings and effects regarding each of the analysis apparatus 100 and the analysis method according to the second embodiment are similar to those regarding the analysis method of the analysis apparatus 100 according to the first embodiment.

The configuration of the analysis apparatus 100 described above may be modified as appropriate, and the procedure of the analysis method described above may be modified as appropriate. Note that any two or more of the following series of modification examples may be combined with each other.

In each of the first embodiment and the second embodiment, the calculation process by the calculator 10 is performed, and thereafter, the measurement process by the measurer 20 is performed. However, the measurement process by the measurer 20 may be performed, and thereafter, the calculation process by the calculator 10 may be performed. In this case also, it is possible to cause the comparison device 30 to perform the comparison process. Accordingly, it is possible to achieve similar effects.

FIG. 2 illustrates a block configuration of an analysis apparatus 200 according to Modification example 2, and corresponds to FIG. 1.

As illustrated in FIG. 1, the analysis apparatus 100 includes the calculator 10, the measurer 20, and the comparison device 30. However, as illustrated in FIG. 2, the analysis apparatus 200 may simply include the calculator 10 and include neither the measurer 20 nor the comparison device 30.

The configuration of the analysis apparatus 200 is similar to that of the analysis apparatus 100, except that the analysis apparatus 200 includes neither the measurer 20 nor the comparison device 30, and outputs the data D1 to the outside.

Specifically, when an electrolytic solution having any configuration has not yet been analyzed by the analysis apparatus 100, the comparison between the calculated DRS signal S2 and the measured DRS signal S3 has not yet been performed, and the assignment of the measured DRS signal S3 based on the individually calculated DRS signal S1 has not yet been performed either. Therefore, the reliability of each of the individually calculated DRS signal S1 and the calculated DRS signal S2 has not yet been guaranteed. In this case, in order to guarantee the reliability of the calculated DRS signal S2, it is necessary to perform not only the calculation process of the calculated DRS signal S2 by the calculator 10 but also the measurement process of the measured DRS signal S3 by the measurer 20 and the comparison process between the calculated DRS signal S2 and the measured DRS signal S3 by the comparison device 30. Therefore, the analysis apparatus 100 needs to include not only the calculator 10 but also the measurer 20 and the comparison device 30, as illustrated in FIG. 1.

In contrast, when the electrolytic solution having any configuration has been analyzed by the analysis apparatus 100, the comparison between the calculated DRS signal S2 and the measured DRS signal S3 has already been performed, and the assignment of the measured DRS signal S3 based on the individually calculated DRS signal S1 has also already been performed. Therefore, the reliability of each of the individually calculated DRS signal S1 and the calculated DRS signal S2 has already been guaranteed. In this case, it is not necessary to further guarantee the reliability of the calculated DRS signal S2. Therefore, it is necessary to simply perform the calculation process of the calculated DRS signal S2 by the calculator 10; and it is unnecessary to perform the measurement process of the measured DRS signal S3 by the measurer 20 and the comparison process between the calculated DRS signal S2 and the measured DRS signal S3 by the comparison device 30. Accordingly, the calculated DRS signal S2 (the individually calculated DRS signal S1) whose reliability has already been guaranteed is usable as it is. For such a reason, the analysis apparatus 200 may simply include the calculator 10 and include neither the measurer 20 nor the comparison device 30, as illustrated in FIG. 2.

That is, when the reliability of the calculated DRS signal S2 has already been guaranteed, the analysis apparatus 200 simply including the calculator 10 and including neither the measurer 20 nor the comparison device 30 may be used instead of the analysis apparatus 100 including the calculator 10, the measurer 20, and the comparison device 30.

In the analysis apparatus 200, the calculator 10 may calculate the individually calculated DRS signal S1 in accordance with Calculation procedure 1 described in the first embodiment, or the calculator 10 may calculate the individually calculated DRS signal S1 in accordance with Calculation procedure 2 described in the second embodiment.

Specifically, when Calculation procedure 1 is used, the calculator 10 may perform the MD calculation, calculate the total electric dipole moment, calculate the time correlation function, approximate the time correlation function with an exponential function, Fourier transform the approximation result of the time correlation function, calculate each of the individually calculated DRS signal S1 and the calculated DRS signal S2, calculate the physical property value P, and output the data D1 to the outside.

When Calculation procedure 2 is used, the calculator 10 may perform the MD calculation, calculate the individual electric dipole moment, calculate the rotational correlation function, approximate the rotational correlation function with an exponential function, calculate the rotational correlation time, calculate each of the individually calculated DRS signal S1 and the calculated DRS signal S2, calculate the physical property value P, and output the data D1.

In this case also, the reliability of the calculated DRS signal S2 (the individually calculated DRS signal S1) is guaranteed. It is therefore possible to easily and highly accurately analyze the physical property of the electrolytic solution, for the reasons described in each of the first and second embodiments.

In the first embodiment, the calculator 10 uses Calculation procedure 1 to calculate the individually calculated DRS signal S1. In the second embodiment, the calculator 10 uses Calculation procedure 2 to calculate the individually calculated DRS signal S1.

However, the calculator 10 may use both Calculation procedures 1 and 2 to calculate the individually calculated DRS signal S1. In this case, the individually calculated DRS signal S1 calculated in accordance with Calculation procedure 1 and the individually calculated DRS signal S1 calculated in accordance with Calculation procedure 2 may be compared with each other to finally determine the individually calculated DRS signal S1. This further improves calculation accuracy of the individually calculated DRS signal S1. Accordingly, it is possible to achieve higher effects.

Note that when only either Calculation procedure 1 or Calculation procedure 2 is used, it is preferable to use Calculation procedure 1.

However, when only Calculation procedure 1 is used, reproducibility of the individually calculated DRS signal S1 can be insufficient due to lack of statistics, depending on a factor such as a cell size or a calculation time. Therefore, in order to sufficiently increase the reliability of the individually calculated DRS signal S1 by sufficiently increasing the calculation accuracy of the individually calculated DRS signal S1, it is preferable to use both Calculation procedures 1 and 2, as described in Modification example 2.

In the second embodiment, the relaxation model is assumed to be the Debye relaxation for the calculator 10 to calculate the individually calculated DRS signal S1. However, the relaxation model is not particularly limited, and may therefore be changed as desired.

Specifically, the relaxation model may be a Cole-Davidson relaxation as well as the Debye relaxation. When the relaxation model is assumed to be the Cole-Davidson relaxation, the characteristic times τₘ and τₓ, the relaxation strengths Δεₘ and Δεₓ, etc. described above may be used as they are, but it should be noted that additional parameters are required. However, the additional parameters described above are identified by applying the least squares method to each of the calculated DRS signal S2 (the individually calculated DRS signal S1) and the measured DRS signal S3. When the Cole-Davidson relaxation is used as the relaxation model also, it is possible to assign the measured DRS signal S3, based on the individually calculated DRS signal S1, as when the relaxation model is assumed to be the Debye relaxation.

In this case also, the reliability of the calculated DRS signal S2 (the individually calculated DRS signal S1) is guaranteed, and the measured DRS signal S3 is assigned based on the individually calculated DRS signal S1. It is therefore possible to easily and highly accurately analyze the physical property of the electrolytic solution.

Note that Modification example 2 described above may be applied not only to the second embodiment, but also to each of Modification examples 2 and 3. In this case also, it is possible to achieve similar effects.

In the first embodiment, the analysis apparatus 100 includes the comparison device 30 as illustrated in FIG. 1, and the comparison device 30 performs the comparison process between the calculated DRS signal S2 and the measured DRS signal S3 by the image analysis process, as described above.

However, although not specifically illustrated here, the analysis apparatus 100 may not include the comparison device 30. In this case, a display device that displays the calculated DRS signal S2, the measured DRS signal S3, etc. may be used instead of the comparison device 30 to allow a user of the analysis apparatus 100 to perform, with his or her human eyes, the comparison process between the calculated DRS signal S2 and the measured DRS signal S3. In this case also, it is possible to assign the measured DRS signal S3 based on the calculated DRS signal S2. Accordingly, it is possible to achieve similar effects.

### EXAMPLES

A description is given of Examples of the present technology according to an embodiment.

### Example 1

As described below, a physical property of an electrolytic solution was examined by analyzing the electrolytic solution by the analysis apparatus 100 (the analysis method) described in the first embodiment. The electrolytic solution used here included propylene carbonate (PC) as a solvent and lithium hexafluorophosphate (LiPF₆) as an electrolyte salt.

### [Configuration of Analysis Apparatus]

The analysis apparatus 100 had a configuration described below.

### [Configuration of Calculator]

Used as the calculator 10 was WMI-MD as software configured to execute the MD calculation. The software used APPLE&P as a force field.

### [Configuration of Measurer]

Used as the dielectric spectroscopy unit of the measurer 20 were a vector network analyzer (VNA N5234A available from Keysight Technologies), a microwave coaxial cable (MWX221 available from JUNFLON), and an open-ended probe (85070E-020 available from Keysight Technologies). The open-ended probe was coupled to the vector network analyzer via the microwave coaxial cable, as described above.

Employed as the measurement method used by the measurer 20 was the reflection-transmission method (the S-parameter method) in which the reflection coefficients S11 and S22 were used. The reflection coefficient S11 was a reflection coefficient of a first port of the vector network analyzer, and the reflection coefficient S22 was a reflection coefficient of a second port of the vector network analyzer.

Used as the software for calculating the complex dielectric constant (the measured DRS signal S3), based on the reflection coefficients, was software attached to the vector network analyzer described above.

Before the measurement of the measured DRS signal S3, a pure solvent having a known dielectric constant was put inside a measurement cell in an open condition to perform calibration based on the pure solvent. Used as the pure solvent were water, benzonitrile, and N,N-dimethylacetamide.

When the measured DRS signal S3 was to be measured, the electrolytic solution was introduced into the measurement cell with a syringe to bring a tip of the open-ended probe into contact with the electrolytic solution. In this case, attention was paid not to allow air to be included in the electrolytic solution, and a contained amount (a volume) of the electrolytic solution was kept constant during the measurement.

Used as the correction unit of the measurer 20 was spreadsheet software (Excel) available from Microsoft Corporation.

### [Configuration of Comparison Device]

Used as the comparison device 30 was a program configured to qualitatively compare the calculated DRS signal S2 and the measured DRS signal S3, based on the series of comparison points described above, as software configured to execute the comparison process based on the image analysis process. The program was an original program written in Python.

### [Analysis of Electrolytic Solution by Analysis Apparatus]

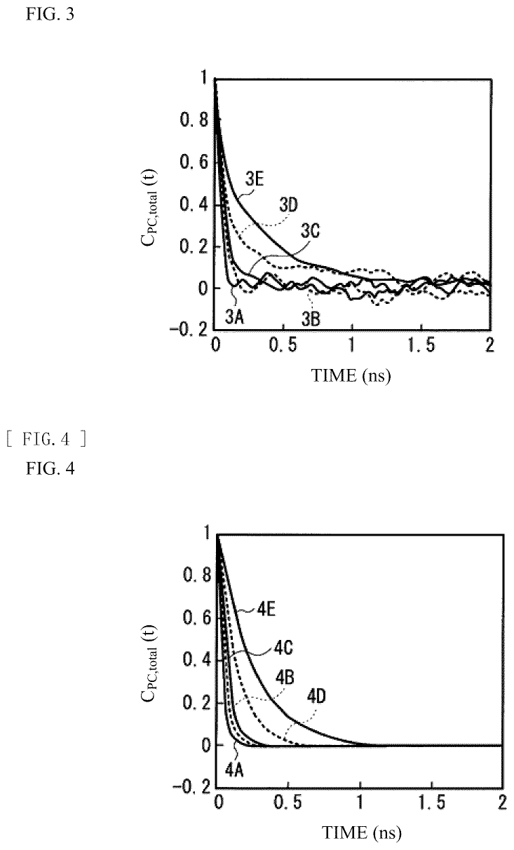

The electrolytic solution was analyzed by the analysis apparatus 100 in accordance with the following procedure. FIGS. 3 to 8 each illustrate an analysis result of the electrolytic solution obtained by the analysis apparatus 100.

Specifically, FIG. 3 illustrates a calculation result of a time correlation function. In FIG. 3, a horizontal axis represents time (ns), and a vertical axis represents the time correlation function. FIG. 4 illustrates an approximation result of the time correlation function. In FIG. 4, a horizontal axis represents time (ns), and a vertical axis represents the time correlation function.

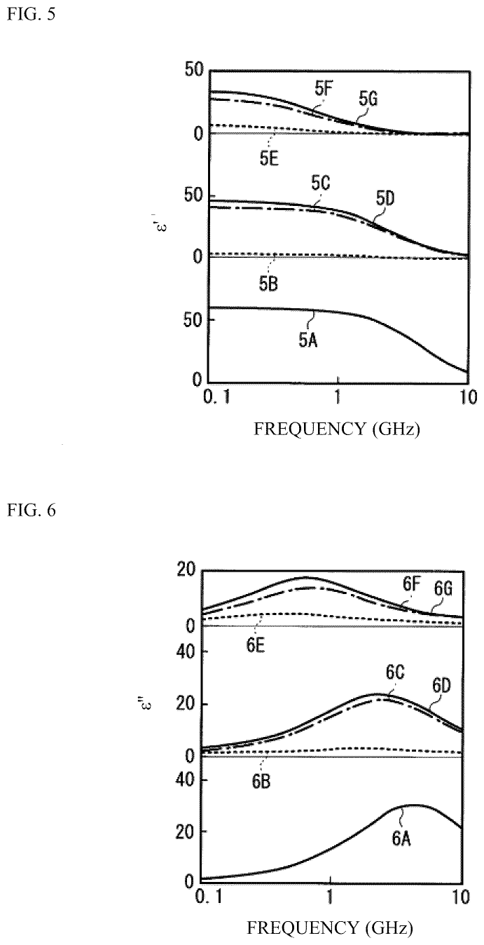

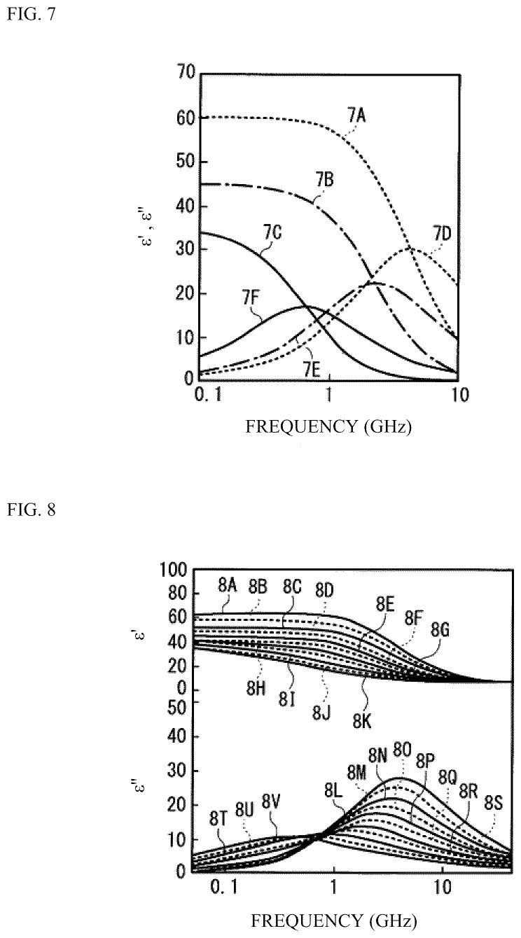

FIG. 5 illustrates a calculation result of the individually calculated DRS signal S1 (the dielectric constant real part) and the calculated DRS signal S2 (the dielectric constant real part). In FIG. 5, a horizontal axis represents a frequency ν (GHz), and a vertical axis represents the dielectric constant real part. FIG. 6 illustrates a calculation result of the individually calculated DRS signal S1 (the dielectric constant imaginary part) and the measured DRS signal S3 (the dielectric constant imaginary part). In FIG. 6, a horizontal axis represents the frequency ν (GHz), and a vertical axis represents the dielectric constant imaginary part. FIG. 7 illustrates a calculation result of the calculated DRS signal S2 (the dielectric constant real part and the dielectric constant imaginary part). In FIG. 7, a horizontal axis represents the frequency ν (GHz), and a vertical axis represents the dielectric constant real part and the dielectric constant imaginary part.

FIG. 8 illustrates a measurement result of the measured DRS signal S3 (the dielectric constant real part and the dielectric constant imaginary part). In FIG. 8, a horizontal axis represents the frequency ν (GHz), and a vertical axis represents the dielectric constant real part and the dielectric constant imaginary part.

### [Calculation of Individually Calculated DRS Signal S1 and Calculation of Calculated DRS Signal S2]

When the electrolytic solution was to be analyzed by the analysis apparatus 100, first, the calculator 10 calculated the individually calculated DRS signal S1 in accordance with Calculation procedure 1, and thereafter calculated the calculated DRS signal S2, as described below.

Specifically, first, the configuration of the electrolytic solution was set in order to perform the MD calculation regarding the electrolytic solution. In this case, PC was set to the solvent and LiPF₆ was set to the electrolyte salt, as described above. Thus, PC (C₄H₆O₃) as the neutral molecule m and CIP (Li⁺PF₆⁻) as the ion pair x were each set to the constituent component C.

The conditions of the MD calculation were set as follows: system size (number of atoms), about 5,000 to about 10,000; time step, 0.5 fs. In this case, a dilute state was set to a starting state, and an equilibrium volume at an ambient temperature and an ambient pressure was acquired in an NPT ensemble in which the number of particles, a pressure, and a temperature were each constant. In addition, an equilibrium calculation was performed at a time of about 10 ns, following which a main calculation was performed. In addition, the calculation was executed for a time of 18 ns or more in the NPT ensemble to acquire a history of behavior (a position, i.e., coordinates) of a series of atoms included in each of the constituent components C.

The following five contents (M=mol/dm³) were set for the electrolyte salt in the electrolytic solution: 0 M, 0.5 M, 1 M, 1.5 M, and 2M. The content of the electrolyte salt described here referred to the content of the electrolyte salt with respect to the solvent.

Thereafter, a total electric dipole moment of each of the constituent components C (the neutral molecule m and the ion pair x (CIP)) was calculated based on the calculation result of the MD calculation. Thereafter, a time correlation function of each of the constituent components C was calculated based on the total electric dipole moment. Note that details of each of the calculation procedure of the total electric dipole moment and the calculation procedure of the time correlation function were as described above.

As a result, specifically focusing on a calculation result of the time correlation function of the neutral molecule m (PC) in the series of constituent components C, the calculation result of the time correlation function illustrated in FIG. 3 was obtained. In FIG. 3, the horizontal axis represents the time (ns), and the vertical axis represents the time correlation function of PC as the neutral molecule m, as described above. Because the five contents were set for the electrolyte salt in the electrolytic solution as described above, FIG. 3 presents five calculation results regarding the time correlation function.

In FIG. 3, 3A to 3E are each related to the content of the electrolyte salt in the electrolytic solution as follows: 3A for 0 M; 3B for 0.5 M; 3C for 1 M; 3D for 1.5 M; and 3E for 2 M.

Thereafter, the time correlation function was approximated by an exponential function. In this case, the time correlation function was fitted by the least squares method. A calculation error of the time correlation function (a variation error of the time correlation function) was thus removed. As a result, the time correlation function was approximated. Note that details of the approximation procedure of the time correlation function were as described above.

As a result, specifically focusing on an approximation result of the time correlation function of the neutral molecule m (PC) in the series of constituent components C, the approximation result of the time correlation function illustrated in FIG. 4 was obtained. That is, the approximation result of the time correlation function illustrated in FIG. 4 corresponds to the calculation result of the time correlation function illustrated in FIG. 3.

In FIG. 4, 4A to 4E are each related to the content of the electrolyte salt in the electrolytic solution as follows: 4A for 0 M; 4B for 0.5 M; 4C for 1 M; 4D for 1.5 M; and 4E for 2 M.

Thereafter, the individually calculated DRS signal S1 (the dielectric constant real part and the dielectric constant imaginary part) of each of the constituent components C was calculated by Fourier transforming the approximation result of the time correlation function. Thereafter, the calculated DRS signal S2 (the dielectric constant real part and the dielectric constant imaginary part) of the electrolytic solution was calculated by adding up the individually calculated DRS signals S1. In this case, the value of the scale factor A was set to 0.25.

Note that details of each of the Fourier transform procedure of the time correlation function, the calculation procedure of the individually calculated DRS signal S1, and the calculation procedure of the calculated DRS signal S2 were as described above.

As a result, the individually calculated DRS signal S1 (the dielectric constant real part) of each of the constituent components C (the neutral molecule m (PC) and the ion pair x (CIP)) was obtained as illustrated in FIG. 5. In addition, the individually calculated DRS signal S1 (the dielectric constant imaginary part) of each of the constituent components C (the neutral molecule m (PC) and the ion pair x (CIP)) was obtained as illustrated in FIG. 6. In FIG. 5, the horizontal axis represents the frequency ν (GHz), and the vertical axis represents the dielectric constant real part, as described above. In FIG. 6, the horizontal axis represents the frequency ν (GHz), and the vertical axis represents the dielectric constant imaginary part, as described above.

In addition, the calculated DRS signal S2 of the electrolytic solution was obtained as illustrated in FIG. 7. In FIG. 7, the horizontal axis represents the frequency ν (GHz), and the vertical axis represents the dielectric constant real part and the dielectric constant imaginary part, as described above.

Note that FIG. 5 illustrates not only the individually calculated DRS signal S1 (the dielectric constant real part) but also the calculated DRS signal S2 (the dielectric constant real part) as described above for easier comparison therebetween.

In FIG. 5, 5A to 5G are each related to the content of the electrolyte salt in the electrolytic solution as follows: 5A for 0 M; each of 5B to 5D for 1 M; and each of 5E to 5G for 2 M. Further, in FIG. 5, each of 5C and 5F indicates the individually calculated DRS signal S1 of the neutral molecule m (PC); each of 5B and 5E indicates the individually calculated DRS signal S1 of the ion pair x (CIP); and each of 5A, 5D, and 5G indicates the calculated DRS signal S2.

Note that FIG. 6 illustrates not only the individually calculated DRS signal S1 (the dielectric constant imaginary part) but also the calculated DRS signal S2 (the dielectric constant imaginary part) as described above for easier comparison therebetween.

In FIG. 6, 6A to 6G are each related to the content of the electrolyte salt in the electrolytic solution as follows: 6A for 0 M; each of 6B to 6D for 1 M; and each of 6E to 6G for 2 M. Further, in FIG. 6, each of 6C and 6F indicates the individually calculated DRS signal S1 of the neutral molecule m (PC); each of 6B and 6E indicates the individually calculated DRS signal S1 of the ion pair x (CIP); and each of 6A, 6D, and 6G indicates the calculated DRS signal S2.

Note that FIG. 7 illustrates the dielectric constant real part and the dielectric constant imaginary part together in one diagram (FIG. 7), for easier comparison between the dielectric constant real part and the dielectric constant imaginary part. In this case, a positional relationship between the dielectric constant real part and the dielectric constant imaginary part is appropriately adjusted.

In FIG. 7, 7A to 7F are each related to the content of the electrolyte salt in the electrolytic solution as follows: each of 7A and 7D for 0 M; each of 7B and 7E for 1 M; and each of 7C and 7F for 2 M. Further, in FIG. 7, each of 7A to 7C indicates the calculated DRS signal S2 (the dielectric constant real part), and each of 7D to 7F indicates the calculated DRS signal S2 (the dielectric constant imaginary part).

### [Calculation of Physical Property Value P]

Thereafter, the physical property value P unique to each of the constituent components C was calculated by the calculator 10, based on the individually calculated DRS signal S1 and the calculated DRS signal S2.

Here, each of the relaxation strength Δεₘ, the characteristic time τₘ, the concentration nₘ, and the static dielectric constant εₘ^{sta} was calculated as the physical property value P of the neutral molecule m (PC). Further, each of the relaxation strength Δεₓ, the characteristic time τₓ, the concentration nₓ, and the static dielectric constant εₓ^{sta} was calculated as the physical property value P of the ion pair x (CIP). In addition, the salt dissociation degree α of the electrolytic solution was calculated. Note that the calculation procedure of each of the physical property values P was as described above.

As a result, the physical property values P when the content of the electrolyte salt in the electrolytic solution was 1 M were as follows. The physical property values P of the neutral molecule m (PC) were as follows: the relaxation strength Δεₘ, 41.5; the characteristic time τₘ, 66.5 ps; the concentration nₘ, 11.4 M; and the static dielectric constant εₘ^{sta}, 41.5. The physical property values P of the ion pair x (CIP) were as follows: the relaxation strength Δεₓ, 1.0; the characteristic time τₓ, 76.0 ps; the concentration nₓ, 0.1 M; and the static dielectric constant εₓ^{sta}, 1.0. The salt dissociation degree α of the electrolytic solution was 0.76.

Thus, the data D1 was outputted from the calculator 10 to the comparison device 30. Details of the data D1 were as described above.

### [Measurement of Measured DRS Signal S3]

Thereafter, the measured DRS signal S3 was measured by the measurer 20 as described below.

Specifically, first, the electrolytic solution was prepared. In this case, the electrolyte salt (LiPF₆) was added to the solvent (PC), following which the solvent was stirred to prepare the electrolytic solution, as described above.

The following eleven contents (M) were set for the electrolyte salt in the electrolytic solution: 0 M, 0.2 M, 0.4 M, 0.6 M, 0.8 M, 1 M, 1.2 M, 1.4 M, 1.6 M, 1.8 M, and 2 M. The content of the electrolyte salt described here referred to the content of the electrolyte salt with respect to the solvent.

Thereafter, the measured DRS signal S3 of the electrolytic solution was measured by analyzing the electrolytic solution by the dielectric relaxation spectroscopy. In this case, the electrolytic solution (at a temperature of 25° C.) was irradiated with a microwave (having a frequency within a range from 200 MHz to 43.5 GHz both inclusive), following which a response wave (a reflected component and a transmitted component of the microwave) was received. The measured DRS signal S3 (the dielectric constant real part and the dielectric constant imaginary part) was thus calculated based on the received response wave.

Thereafter, the measured DRS signal S3 was corrected in order to remove a measurement error derived from ionic conductivity of the electrolytic solution. In this case, the measured DRS signal S3 was fitted by the Debye relaxation function as described above. The measurement error derived from a motion other than a rotational motion was thus removed from the measured DRS signal S3. As a result, the measured DRS signal S3 was corrected.

The measurement result of the measured DRS signal S3 was thus obtained as illustrated in FIG. 8. In FIG. 8, the horizontal axis represents the frequency ν (GHz), and the vertical axis represents the dielectric constant real part and the dielectric constant imaginary part, as described above.

Note that FIG. 8 illustrates the dielectric constant real part and the dielectric constant imaginary part together in one diagram (FIG. 8), for easier comparison between the dielectric constant real part and the dielectric constant imaginary part. Because the eleven contents were set for the electrolyte salt in the electrolytic solution as described above, FIG. 8 presents eleven dielectric constant real parts and eleven dielectric constant imaginary parts.

In FIG. 8, 8A to 8K are each related to the content of the electrolyte salt in the electrolytic solution as follows: each of 8A and 8L for 0 M; each of 8B and 8M for 0.2 M; each of 8C and 8N for 0.4 M; each of 8D and 8O for 0.6 M; each of 8E and 8P for 0.8 M; each of 8F and 8Q for 1 M; each of 8G and 8R for 1.2 M; each of 8H and 8S for 1.4 M; each of 8I and 8T for 1.6 M; each of 8J and 8U for 1.8 M; and each of 8K and 8V for 2 M. Further, in FIG. 8, each of 8A to 8K indicates the measured DRS signal S3 (the dielectric constant real part), and each of 8L to 8V indicates the measured DRS signal S3 (the dielectric constant imaginary part).

Lastly, the data D2 was outputted from the measurer 20 to the comparison device 30. Details of the data D2 were as described above.

### [Comparison Between Calculated DRS Signal S2 and Measured DRS Signal S3, and Assignment of Measured DRS Signal S3 Based on Individually Calculated DRS Signal S1]

Lastly, the calculated DRS signal S2 and the measured DRS signal S3 were compared with each other by the comparison device 30, as described below.

Specifically, it was confirmed whether a spectrum shape of the calculated DRS signal S2 illustrated in FIG. 7 and a spectrum shape of the measured DRS signal S3 illustrated in FIG. 8 qualitatively coincided with each other. As a result, the following tendencies were found out.

Specifically, first, in each of the calculated DRS signal S2 and the measured DRS signal S3, when the content of the electrolyte salt in the electrolytic solution increased from 0 M to 2 M, the frequency ν (what is called a peak position) at which the intensity of the dielectric constant imaginary part became the maximum decreased. More specifically, the frequency ν decreased from about 5 GHz to about 0.5 GHz.

Second, in each of the calculated DRS signal S2 and the measured DRS signal S3, when the content of the electrolyte salt in the electrolytic solution increased from 0 M to 2 M, the maximum value (what is called a peak intensity) of the intensity of the dielectric constant imaginary part decreased. More specifically, the intensity of the dielectric constant imaginary part decreased from about 30 to about 12.

Third, in each of the calculated DRS signal S2 and the measured DRS signal S3, when the content of the electrolyte salt in the electrolytic solution increased from 0 M to 2 M, the static dielectric constant ε^{sta} decreased. More specifically, the static dielectric constant ε^{sta} decreased from about 60 to about 35.

Based on the above-described tendencies, the calculated DRS signal S2 and the measured DRS signal S3 qualitatively coincided with each other. Thus, the reliability of the calculated DRS signal S2 with respect to the measured DRS signal S3 was guaranteed, and thus, the reliability of the individually calculated DRS signals S1, which were each a constituent part of the calculated DRS signal S2, was also guaranteed. It was thus possible to assign the measured DRS signal S3, based on the individually calculated DRS signals S1.

Lastly, the analysis apparatus 100 outputted the data D3 to the outside. Details of the data D3 were as described above. Thus, the analysis of the electrolytic solution by the analysis apparatus 100 was completed.

The reliability of the calculated DRS signal S2 of the electrolytic solution was guaranteed, and thus, the reliability of the individually calculated DRS signal S1 of each of the constituent components C (the neutral molecule m (PC) and the ion pair x (CIP)) was guaranteed. Accordingly, the following physical properties were derived from the results presented in FIGS. 3 to 8.

First, as is apparent from FIGS. 5 to 8, within a range in which the content of the electrolyte salt in the electrolytic solution was from 0 M to 2 M both inclusive, the spectrum shape of the measured DRS signal S3 was determined mainly depending on the spectrum shape of the neutral molecule m (PC).

Second, as is apparent from FIG. 7, the frequency ν at which the individually calculated DRS signal S1 (the dielectric constant imaginary part) of the neutral molecule m (PC) became the maximum decreased in accordance with an increase in the content of the electrolyte salt in the electrolytic solution. This implied that when the content of the electrolytic salt in the electrolytic solution increased, mobility of the neutral molecule m (PC) decreased.

Similarly, the frequency ν at which the intensity of the individually calculated DRS signal S1 (the dielectric constant imaginary part) of the ion pair x (CIP) became the maximum decreased in accordance with an increase in the content of the electrolyte salt in the electrolytic solution. This implied that when the content of the electrolytic salt in the electrolytic solution increased, mobility of the ion pair x (CIP) also decreased.

Third, as is apparent from FIGS. 5 and 6, the intensity of the individually calculated DRS signal S1 (the dielectric constant imaginary part) of the ion pair x (CIP) increased in accordance with an increase in the content of the electrolyte salt in the electrolytic solution. Accordingly, when the content of the electrolyte salt in the electrolytic solution increased, the concentration of the ion pair x (CIP) increased.

In this case, the frequency (an average coordination number) at which the cation (Li⁺) and the anion (PF₆⁻) came into contact with each other was actually calculated based on the trajectory of the MD calculation. It was thus confirmed that the average coordination number increased in accordance with an increase in the content of the electrolyte salt in the electrolytic solution.

Fourth, as is apparent from FIG. 6, in the same system (the electrolytic solution), the characteristic frequency νₓ of the ion pair x (CIP) was lower than the characteristic frequency νₘ of the neutral molecule m (PC). This implied that a response of the ion pair x (CIP) to an external electric field was slower than a response of the neutral molecule m (PC) to the external electric field, and therefore, the mobility of the ion pair x (CIP) was lower than the mobility of the neutral molecule m (PC).

Fifth, as is apparent from FIG. 5, each of the static dielectric constant εₘ^{sta} of the neutral molecule m (PC) and the static dielectric constant εₓ^{sta} of the ion pair x (CIP) decreased in accordance with an increase in the content of the electrolyte salt in the electrolytic solution.

From the above, new and useful information was obtained on the physical property of the electrolytic solution in which the solvent (PC) and the electrolyte salt (LiPF₆) were included and the constituent components C thus included the neutral molecule m (PC) and the ion pair x (CIP).

In more detail, it was possible to acquire the physical property values P (the relaxation strengths Δεₘ and Δεₓ, the characteristic times τₘ and τₓ, the concentrations nₘ and nₓ, the static dielectric constants εₘ^{sta} and εₓ^{sta}, and the salt dissociation degree α) of each of the constituent components C, based on the individually calculated DRS signals S1 and the calculated DRS signal S2. In this case, it was possible to find out the mobility of each of the constituent components C, and to find out the dependency, of the mobility of each of the constituent components C, on the concentration of the electrolytic solution.

In addition, it was possible to find out not only the physical property of the neutral molecule m, which was chemically static, but also the physical property of the ion pair x (CIP), which was chemically dynamic. In this case, it was also possible to estimate an ionic dissociation property of the electrolyte salt in the electrolytic solution, based on the concentration of the ion pair x.

In addition, the use of the measurement error derived from the ionic conductivity, which was calculated in the measurement process of the measured DRS signal S3, made it possible to estimate the ionic conductivity of the electrolytic solution.

### Experiment Example 2

As described below, a physical property of an electrolytic solution was examined by analyzing the electrolytic solution by the analysis apparatus 100 (the analysis method) described in the second embodiment. The electrolytic solution used here included propylene carbonate (PC) and diethyl carbonate (DEC) as a mixture solvent, and lithium hexafluorophosphate (LiPF₆) as an electrolyte salt. In this case, a mixture ratio (a weight ratio) of the mixture solvent was set as follows: PC:DEC=30:70.

### [Configuration of Analysis Apparatus]

The analysis apparatus 100 in Example 2 had a configuration similar to the configuration of the analysis apparatus 100 in Example 1, except that Calculation procedure 2 was used instead of Calculation procedure 1 to cause the calculator 10 to calculate the individually calculated DRS signal S1.

### [Analysis of Electrolytic Solution by Analysis Apparatus]

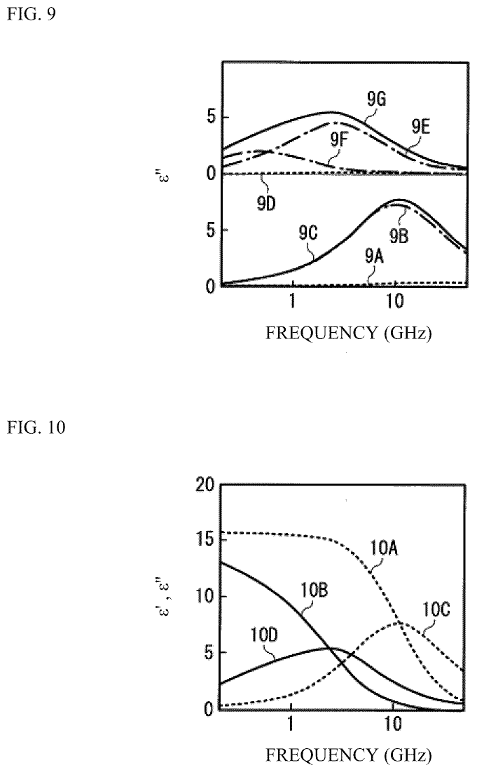

The electrolytic solution was analyzed by the analysis apparatus 100 in accordance with the following procedure. FIGS. 9 to 11 each illustrate an analysis result of the electrolytic solution by the analysis apparatus 100.

Specifically, FIG. 9 illustrates a calculation result of the individually calculated DRS signal S1 (the dielectric constant imaginary part) and the calculated DRS signal S2 (the dielectric constant imaginary part). In FIG. 9, a horizontal axis represents the frequency ν (GHz), and a vertical axis represents the dielectric constant imaginary part. FIG. 10 illustrates a calculation result of the calculated DRS signal S2 (the dielectric constant real part and the dielectric constant imaginary part). In FIG. 10, a horizontal axis represents the frequency ν (GHz), and a vertical axis represents the dielectric constant real part and the dielectric constant imaginary part.

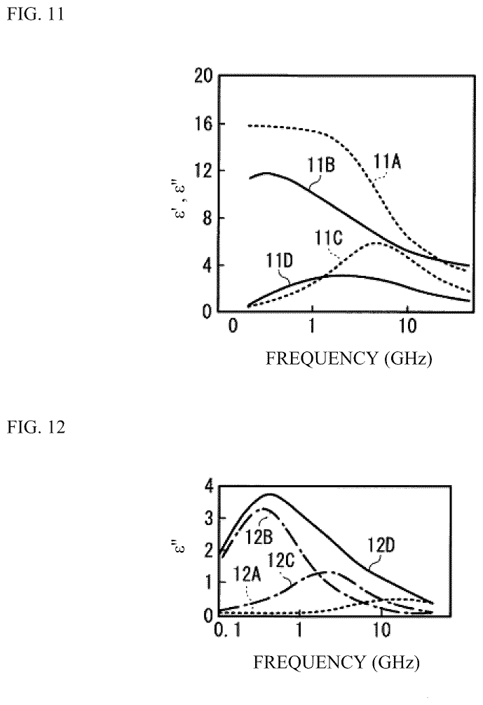

FIG. 11 illustrates a measurement result of the measured DRS signal S3 (the dielectric constant real part and the dielectric constant imaginary part). In FIG. 11, a horizontal axis represents the frequency ν (GHz), and a vertical axis represents the dielectric constant real part and the dielectric constant imaginary part.

### [Calculation of Individually Calculated DRS Signal S1 and Calculation of Calculated DRS Signal S2]

When the electrolytic solution was to be analyzed by the analysis apparatus 100, first, the calculator 10 calculated the calculated DRS signal S1 of each of the constituent components C in accordance with Calculation procedure 2, and calculated the calculated DRS signal S2 of the electrolytic solution.

Specifically, first, the configuration of the electrolytic solution was set in order to perform the MD calculation regarding the electrolytic solution. In this case, PC and DEC were set to the solvent, and LiPF₆ was set to the electrolyte salt, as described above. Thus, propylene carbonate (C₄H₆O₃) and diethyl carbonate (C₅H₁₀O₃) as the neutral molecules m and CIP (Li⁺PF₆⁻) as the ion pair x were each set to the constituent component C.

Thereafter, the MD calculation regarding the electrolytic solution was executed. The calculation procedure of the MD calculation was similar to that in Example 1. The following two contents were set for the electrolyte salt in the electrolytic solution: 0 M and 1 M. The content of the electrolyte salt described here referred to the content of the electrolyte salt with respect to the solvent, as described above.

Thereafter, an individual electric dipole moment of each of the constituent components C (the neutral molecule m and the ion pair x (CIP)) was calculated based on a calculation result of the MD calculation, following which a rotational correlation function of each of the constituent components C was calculated based on the individual electric dipole moment. In addition, a rotational correlation time of each of the constituent components C was calculated by approximating the rotational correlation function with an exponential function. Further, the individually calculated DRS signal S1 (the dielectric constant real part and the dielectric constant imaginary part) of each of the constituent components C was calculated based on the rotational correlation time, following which the calculated DRS signal S2 (the dielectric constant real part and the dielectric constant imaginary part) of the electrolytic solution was calculated.

Note that details of each of the calculation procedure of the individual electric dipole moment, the calculation procedure of the rotational correlation function, the approximation procedure of the rotational correlation function, the calculation procedure of the rotational correlation time, the calculation procedure of the individually calculated DRS signal S1, and the calculation procedure of the calculated DRS signal S2 were as described above.

As a result, the individually calculated DRS signal S1 (the dielectric constant imaginary part) of each of the constituent components C (the neutral molecules m (PC and DEC) and the ion pair x (CIP)) was obtained as illustrated in FIG. 9. In FIG. 9, the horizontal axis represents the frequency ν (GHz), and the vertical axis represents the dielectric constant imaginary part, as described above.

In addition, the calculated DRS signal S2 of the electrolytic solution was obtained as illustrated in FIG. 10. In FIG. 10, the horizontal axis represents the frequency ν (GHz), and the vertical axis represents the dielectric constant real part and the dielectric constant imaginary part, as described above.

Note that FIG. 9 illustrates not only the individually calculated DRS signal S1 (the dielectric constant imaginary part) but also the calculated DRS signal S2 (the dielectric constant imaginary part). In FIG. 10, a positional relationship between the dielectric constant real part and the dielectric constant imaginary part is adjusted.

In FIG. 9, 9A to 9G are each related to the content of the electrolyte salt in the electrolytic solution as follows: each of 9A to 9C for 0 M; and each of 9D to 9G for 1 M. Further, in FIG. 9, each of 9A and 9D indicates the individually calculated DRS signal S1 of the neutral molecule m (DEC), each of 9B and 9E indicates the individually calculated DRS signal S1 of the neutral molecule m (PC), 9F indicates the individually calculated DRS signal S1 of the ion pair x (CIP), and each of 9C and 9G indicates the calculated DRS signal S2.

In FIG. 10, 10A to 10D are each related to the content of the electrolyte salt in the electrolytic solution as follows: each of 10A and 10C for 0 M; and each of 10B and 10D for 1 M. Further, in FIG. 10, each of 10A and 10B indicates the calculated DRS signal S2 (the dielectric constant real part), and each of 10C and 10D indicates the calculated DRS signal S2 (the dielectric constant imaginary part).

### [Calculation of Physical Property Value P]

Thereafter, the physical property value P unique to each of the constituent components C was calculated by the calculator 10, based on the individually calculated DRS signal S1 and the calculated DRS signal S2.

Here, each of the relaxation strength Δεₘ, the characteristic time τₘ, the concentration nₘ, and the static dielectric constant εₘ^{sta} was calculated as the physical property value P of each of the neutral molecules m (PC and DEC). Further, each of the relaxation strength Δεₓ, the characteristic time τₓ, the concentration nₓ, and the static dielectric constant εₓ^{sta} was calculated as the physical property value P of the ion pair x (CIP). In addition, the salt dissociation degree α of the electrolytic solution was calculated.

As a result, the physical property values P when the content of the electrolyte salt in the electrolytic solution was 1 M were as follows. The physical property values P of the neutral molecule m (PC) were as follows: the relaxation strength Δεₘ, 9.2; the characteristic time τₘ, 31.5 ps; the concentration nₘ, 2.9 M; and the static dielectric constant εₘ^{sta}, 9.2. The physical property values P of the neutral molecule m (DEC) were as follows: the relaxation strength Δεₘ, 0.6; the characteristic time τₘ, 13.5 ps; the concentration nₘ, 5.9 M; and the static dielectric constant εₘ^{sta} 0.6. The physical property values P of the ion pair x (CIP) were as follows: the relaxation strength Δεₓ, 4.1; the characteristic time τₓ, 180.0 ps; the concentration nₓ, 0.4 M; and the static dielectric constant εₓ^{sta}, 4.1. The salt dissociation degree α of the electrolytic solution was 0.51.

### [Measurement of Measured DRS Signal S3]

Thereafter, the measured DRS signal S3 was measured by the measurer 20 as described below.

Specifically, first, the electrolytic solution was prepared. In this case, the electrolyte salt (LiPF₆) was added to the mixture solvent (PC and DEC) as described above, following which the mixture solvent was stirred to prepare the electrolytic solution.

The following two contents (M) were set for the electrolyte salt in the electrolytic solution: 0 M and 1 M. The content of the electrolyte salt described here referred to the content of the electrolyte salt with respect to the solvent.

Thereafter, the measured DRS signal S3 of the electrolytic solution was measured by analyzing the electrolytic solution by the dielectric relaxation spectroscopy. Details of the measurement procedure of the measured DRS signal S3 were similar to those in Example 1.

The measured DRS signal S3 was thus obtained as illustrated in FIG. 11. In FIG. 11, the horizontal axis represents the frequency ν (GHz), and the vertical axis represents the dielectric constant real part and the dielectric constant imaginary part, as described above. Note that FIG. 11 illustrates the dielectric constant real part and the dielectric constant imaginary part together. Because the two contents were set for the electrolyte salt in the electrolytic solution as described above, FIG. 11 presents two dielectric constant real parts and two dielectric constant imaginary parts.

In FIG. 11, 11A to 11D are each related to the content of the electrolyte salt in the electrolytic solution as follows: each of 11A and 11C for 0 M; and each of 11B and 11D for 1 M. Further, in FIG. 11, each of 11A and 11B indicates the measured DRS signal S3 (the dielectric constant real part), and each of 11C and 11D indicates the measured DRS signal S3 (the dielectric constant imaginary part).

### [Comparison Between Calculated DRS Signal S2 and Measured DRS Signal S3, and Assignment of Measured DRS Signal S3 Based on Individually Calculated DRS Signal S1]

Lastly, the calculated DRS signal S2 and the measured DRS signal S3 were compared with each other by the comparison device 30, as described below.

Specifically, it was confirmed whether a spectrum shape of the calculated DRS signal S2 illustrated in FIG. 10 and a spectrum shape of the measured DRS signal S3 illustrated in FIG. 11 qualitatively coincided with each other. As a result, the following tendencies were found out.

Specifically, in the measured DRS signal S3, when the content of the electrolyte salt in the electrolytic solution increased, the frequency ν at which the intensity of the dielectric constant imaginary part became the maximum decreased. More specifically, the frequency ν decreased from about 7 GHz to about 2 GHz.

In addition, in the measured DRS signal S3, when the content of the electrolyte salt in the electrolytic solution increased, the maximum value of the intensity of the dielectric constant imaginary part decreased. More specifically, the maximum value of the intensity of the dielectric constant imaginary part decreased from about 6 to about 3.

Further, in the measured DRS signal S3, when the content of the electrolyte salt in the electrolytic solution increased, the intensity of the dielectric constant real part at which the frequency ν became the minimum (=about 0.2 GHZ) decreased. More specifically, the intensity of the dielectric constant real part decreased from about 16 to about 12.

Meanwhile, in the calculated DRS signal S2, when the content of the electrolyte salt in the electrolytic solution increased, the frequency ν at which the intensity of the dielectric constant imaginary part became the maximum decreased. More specifically, the frequency ν decreased from about 10 GHz to about 2 GHz.

In addition, in the calculated DRS signal S2, when the content of the electrolyte salt in the electrolytic solution increased, the maximum value of the intensity of the dielectric constant imaginary part decreased. More specifically, the maximum value of the intensity of the dielectric constant imaginary part decreased from about 8 to about 5.

Further, in the calculated DRS signal S2, when the content of the electrolyte salt in the electrolytic solution increased, the intensity of the dielectric constant real part at which the frequency ν became the minimum (=about 0.2 GHZ) decreased. More specifically, the intensity of the dielectric constant real part decreased from about 16 to about 13.

Based on the above-described tendencies, the calculated DRS signal S2 and the measured DRS signal S3 qualitatively coincided with each other. Thus, the reliability of the calculated DRS signal S2 with respect to the measured DRS signal S3 was guaranteed, and thus, the reliability of the individually calculated DRS signals S1, which were each a constituent part of the calculated DRS signal S2, was also guaranteed. It was thus possible to assign the measured DRS signal S3, based on the individually calculated DRS signals S1.

The reliability of the calculated DRS signal S2 of the electrolytic solution was guaranteed, and thus, the reliability of the individually calculated DRS signal S1 of each of the constituent components C (the neutral molecules m (PC and DEC) and the ion pair x (CIP)) was also guaranteed. Accordingly, the following physical properties were derived from the results illustrated in FIGS. 9 to 11.

First, as is apparent from FIGS. 9 to 11, within a range in which the content of the electrolyte salt in the electrolytic solution was from 0 M to 2 M both inclusive, the spectrum shape of the measured DRS signal S3 was determined mainly depending on the spectrum shape of the neutral molecule m (PC). Therefore, the spectrum shape of the neutral molecule m (DEC) hardly influenced the spectrum shape of the measured DRS signal S3.

However, the frequency ν at which the intensity of the individually calculated DRS signal S1 (the dielectric constant imaginary part) of the neutral molecule m (DEC) became the maximum was higher than the frequency ν at which the intensity of the individually calculated DRS signal S1 (the dielectric constant imaginary part) of the neutral molecule m (PC) became the maximum. This implied that the mobility of the neutral molecule m (DEC) was higher than the mobility of the neutral molecule m (PC).

Note that the spectrum shape of the calculated DRS signal S3 when the content of the electrolyte salt in the electrolytic solution was great (=1 M) was broader than the spectrum shape of the calculated DRS signal S3 when the content of the electrolyte salt in the electrolytic solution was small (=0 M). In this case, the frequency ν at which the intensity of the dielectric constant imaginary part became the maximum in the former was lower than the frequency ν at which the intensity of the dielectric constant imaginary part became the maximum in the latter.

Thus, as described above, it was mainly the neutral molecule m (PC) that determined the spectrum shape of the measured DRS signal S3. However, in a region where the frequency ν was small, an influence of the neutral molecule m (DEC) on the spectrum shape of the measured DRS signal S3 was not so small as well.

Second, as is apparent from FIGS. 7 and 11, the relaxation strength Δεₓ in Example 2 was higher than the relaxation strength Δεₓ in Example 1. The relaxation strength Δεₓ represented an influence of the ion pair x (CIP) on the physical property of the electrolytic solution, as described above. This thus implied that even if the content of the electrolyte salt in the electrolytic solution was constant, an increase in the ratio (the mixture ratio) of DEC in the mixture solvent allowed for easier formation of the ion pair x (CIP) in the electrolytic solution.

From the above, new and useful information was obtained on the physical property of the electrolytic solution that included the mixture solvent (PC and DEC) and the electrolyte salt (LiPF₆) and accordingly included the neutral molecules m (PC and DEC) and the ion pair x (CIP) as the constituent components C.

In more detail, it was possible to obtain advantages similar to those in Example 1. In this case, it was possible to obtain similar advantages also when the mixture solvent was used in particular.

### Experiment Example 3

As described below, a physical property of an electrolytic solution was examined by analyzing the electrolytic solution by the analysis apparatus 100 (the analysis method) described in the first embodiment. The electrolytic solution used here included diethyl carbonate (DEC) as a solvent and lithium hexafluorophosphate (LiPF₆) as an electrolyte salt.

### [Configuration of Analysis Apparatus]

The analysis apparatus 100 in Example 3 had a configuration similar to the configuration of the analysis apparatus 100 in Example 1.

### [Analysis of Electrolytic Solution]

The electrolytic solution was analyzed by the analysis apparatus 100 in accordance with the following procedure. FIGS. 12 to 15 each illustrate an analysis result of the electrolytic solution obtained by the analysis apparatus 100.

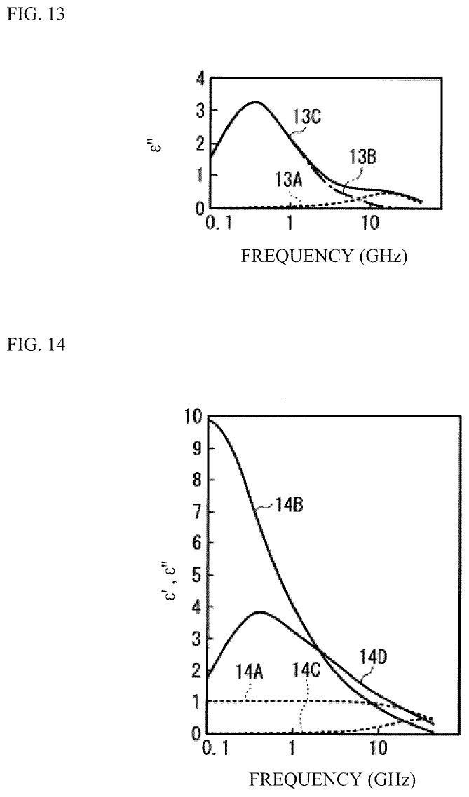

Specifically, FIGS. 12 and 13 each illustrate a calculation result of the individually calculated DRS signal S1 (the dielectric constant imaginary part) regarding the electrolytic solution in which the content of the electrolyte salt was 1 M. In each of FIGS. 12 and 13, a horizontal axis represents the frequency ν (GHz), and a vertical axis represents the dielectric constant imaginary part. Note that FIG. 12 illustrates the calculation result when the constituent component C of a three-component system was used, and FIG. 13 illustrates the calculation result when the constituent component C of a two-component system was used. Details of each of the “three-component system” and the “two-component system” described above will be described later.

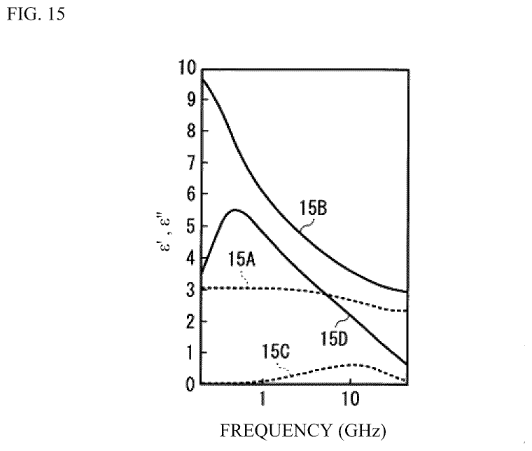

FIG. 14 illustrates a calculation result of the calculated DRS signal S2 (the dielectric constant real part and the dielectric constant imaginary part). In FIG. 14, a horizontal axis represents the frequency ν (GHz), and a vertical axis represents the dielectric constant real part and the dielectric constant imaginary part. FIG. 14 illustrates the calculation result when the constituent component C of the three-component system was used in the electrolytic solution in which the content of the electrolyte salt was 1 M. FIG. 15 illustrates a measurement result of the measured DRS signal S3 (the dielectric constant real part and the dielectric constant imaginary part). In FIG. 15, a horizontal axis represents the frequency ν (GHz), and a vertical axis represents the dielectric constant real part and the dielectric constant imaginary part.

### [Calculation of Individually Calculated DRS Signal S1 and Calculation of Calculated DRS Signal S2]

When the electrolytic solution was to be analyzed by the analysis apparatus 100, first, the calculator 10 calculated the individually calculated DRS signal S1 of each of the constituent components C in accordance with Calculation procedure 1, and calculated the calculated DRS signal S2 of the electrolytic solution, as described below.

Specifically, first, the configuration of the electrolytic solution was set in order to perform the MD calculation regarding the electrolytic solution. In this case, DEC was set to the solvent and LiPF₆ was set to the electrolyte salt as described above.

In this case, DEC (C₅H₁₀O₃) as the neutral molecule m, CIP (Li⁺PF₆⁻) as the ion pair x, and an ion associate (Li₂(PF₆)₂) as the ion pair x were set to the system (the three-component system) including three constituent components C. In this case, a plurality of kinds of ion associates was set, including, without limitation, Li₂PF₆ and Li(PF₆)₂ in addition to Li₂(PF₆)₂, to the ion pair x.

In addition, for comparison, DEC (C₅H₁₀O₃) as the neutral molecule m and CIP (Li⁺PF₆⁻) as the ion pair x were set to the system (the two-component system) including two constituent components C.

Thereafter, the MD calculation regarding the electrolytic solution was executed. A calculation procedure of the MD calculation was similar to that in Example 1. The following two contents were set for the electrolyte salt in the electrolytic solution: 0 M and 1 M.

Thereafter, the individually calculated DRS signal S1 (the dielectric constant real part and the dielectric constant imaginary part) of each of the constituent components C (the neutral molecule m (DEC) and the ion pairs x (CIP and the ion associate)) in the three-component system was calculated based on the calculation result obtained by the MD calculation in accordance with a procedure similar to that in Example 1, following which the calculated DRS signal S2 (the dielectric constant real part and the dielectric constant imaginary part) of the electrolytic solution was calculated.

In addition, for comparison, the individually calculated DRS signal S1 (the dielectric constant real part and the dielectric constant imaginary part) of each of the constituent components C (the neutral molecule m (DEC) and the ion pair x (CIP)) in the two-component system was calculated based on the calculation result obtained by the MD calculation in accordance with a procedure similar to that in Example 1, following which the calculated DRS signal S2 (the dielectric constant real part and the dielectric constant imaginary part) of the electrolytic solution was calculated.

As a result, the individually calculated DRS signals S1 (the dielectric constant imaginary part) regarding the three-component system (in which the constituent components C were the neutral molecule m (DEC) and the ion pairs x (CIP and the ion associate)) were obtained as illustrated in FIG. 12. In FIG. 12, the horizontal axis represents the frequency ν (GHz), and the vertical axis represents the dielectric constant imaginary part, as described above.

In addition, the individually calculated DRS signals S1 (the dielectric constant imaginary part) regarding the second-component system (in which the constituent components C were the neutral molecule m (DEC) and the ion pair x (CIP)) were obtained as illustrated in FIG. 13. In FIG. 13, the horizontal axis represents the frequency ν (GHz), and the vertical axis represents the dielectric constant imaginary part, as described above.

In addition, the calculated DRS signal S2 of the electrolytic solution was obtained as illustrated in FIG. 14. In FIG. 14, the horizontal axis represents the frequency ν (GHz), and the vertical axis represents the dielectric constant real part and the dielectric constant imaginary part, as described above.

Note that FIGS. 12 and 13 each illustrate not only the individually calculated DRS signal S1 but also the calculated DRS signal S2, as described above. In FIG. 14, a positional relationship between the dielectric constant real part and the dielectric constant imaginary part is adjusted.

In FIG. 12, 12A to 12D are each related to the content of the electrolyte salt in the electrolytic solution as follows: each of 12A to 12D for 1 M. Further, in FIG. 12, 12A indicates the individually calculated DRS signal S1 (the dielectric constant imaginary part) of the neutral molecule m (DEC), 12B indicates the individually calculated DRS signal S1 (the dielectric constant imaginary part) of the ion pair x (CIP), 12C indicates the individually calculated DRS signal S1 (the dielectric constant imaginary part) of the ion pair x (the ion associate), and 12D indicates the calculated DRS signal S2 (the dielectric constant imaginary part) of the electrolytic solution.

In FIG. 13, 13A to 13C are each related to the content of the electrolyte salt in the electrolytic solution as follows: each of 13A to 13C for 1 M. Further, in FIG. 13, 13A indicates the individually calculated DRS signal S1 (the dielectric constant imaginary part) of the neutral molecule m (DEC), 13B indicates the individually calculated DRS signal S1 (the dielectric constant imaginary part) of the ion pair x (CIP), and 13C indicates the calculated DRS signal S2 (the dielectric constant imaginary part) of the electrolytic solution.

In FIG. 14, 14A to 14D are each related to the content of the electrolyte salt in the electrolytic solution as follows: each of 14A and 14C for 0 M; and each of 14B and 14D for 1 M. Further, in FIG. 14, each of 14A and 14B indicates the calculated DRS signal S2 (the dielectric constant real part), and each of 14C and 14D indicates the calculated DRS signal S2 (the dielectric constant imaginary part).

### [Calculation of Physical Property Value P]

Thereafter, the physical property value P unique to each of the constituent components C was calculated by the calculator 10, based on the individually calculated DRS signal S1 and the calculated DRS signal S2.

Here, each of the relaxation strength Δεₘ, the characteristic time τₘ, the concentration nₘ, and the static dielectric constant εₘ^{sta} was calculated as the physical property value P of the neutral molecule m (DEC). Further, each of the relaxation strength Δεₓ, the characteristic time τₓ, the concentration nₓ, and the static dielectric constant εₓ^{sta} was calculated as the physical property value P of each of the ion pairs x (CIP and the ion associate). In addition, the salt dissociation degree α of the electrolytic solution was calculated.

As a result, the physical property values P when the content of the electrolyte salt in the electrolytic solution was 1 M were as follows. The physical property values P of the neutral molecule m (DEC) were as follows: the relaxation strength Δεₘ, 0.9; the characteristic time τₘ, 9.3 ps; the concentration nₘ, 7.8 M; and the static dielectric constant εₘ^{sta}, 0.9. The physical property values P of the ion pair x (CIP) were as follows: the relaxation strength Δεₓ, 6.5; the characteristic time τₓ, 453.0 ps; the concentration nₓ, 0.5 M; and the static dielectric constant εₓ^{sta}, 6.5. The physical property values P of the ion pair x (the ion associate) were as follows: the relaxation strength Δεₓ, 2.7; the characteristic time τₓ, 76.0 ps; the concentration nₓ, 0.1 M; and the static dielectric constant εₓ^{sta}, 2.7. The salt dissociation degree α of the electrolytic solution was 0.28.

### [Measurement of Measured DRS Signal S3]

Thereafter, the measured DRS signal S3 was measured by the measurer 20 as described below.

Specifically, first, the electrolytic solution was prepared. In this case, the electrolyte salt (LiPF₆) was added to the solvent (DEC) as described above, following which the solvent was stirred to prepare the electrolytic solution.

The following two contents (M) were set for the electrolyte salt in the electrolytic solution: 0 M and 1 M. The content of the electrolyte salt described here referred to the content of the electrolyte salt with respect to the solvent.

Thereafter, the measured DRS signal S3 of the electrolytic solution was measured by analyzing the electrolytic solution by the dielectric relaxation spectroscopy. The measurement procedure of the measured DRS signal S3 was similar to that in Example 1.

The measured DRS signal S3 (the dielectric constant real part and the dielectric constant imaginary part) was thus obtained as illustrated in FIG. 15. In FIG. 15, the horizontal axis represents the frequency ν (GHz), and the vertical axis represents the dielectric constant real part and the dielectric constant imaginary part, as described above. Note that FIG. 15 illustrates the dielectric constant real part and the dielectric constant imaginary part together. Because the two contents were set for the electrolyte salt in the electrolytic solution as described above, FIG. 15 presents two dielectric constant real parts and two dielectric constant imaginary parts.

In FIG. 15, 15A to 15D are each related to the content of the electrolyte salt in the electrolytic solution as follows: each of 15A and 15C for 0 M; and each of 15B and 15D for 1 M. Further, in FIG. 15, each of 15A and 15B indicates the measured DRS signal S3 (the dielectric constant real part), and each of 15C and 15D indicates the measured DRS signal S3 (the dielectric constant imaginary part).

### [Comparison Between Calculated DRS Signal S2 and Measured DRS Signal S3, and Assignment of Measured DRS Signal S3, Based on Individually Calculated DRS Signals S1]

Lastly, the calculated DRS signal S2 and the measured DRS signal S3 were compared with each other by the comparison device 30, as described below.

Specifically, it was confirmed whether a spectrum shape of the calculated DRS signal S2 illustrated in FIG. 14 and a spectrum shape of the measured DRS signal S3 illustrated in FIG. 15 qualitatively coincided with each other. As a result, the following tendencies were found out.

Specifically, in the measured DRS signal S3, when the content of the electrolyte salt in the electrolytic solution increased, the frequency ν at which the intensity of the dielectric constant imaginary part became the maximum decreased. More specifically, the frequency ν decreased from about 20 GHz to about 0.5 GHz.

In addition, in the measured DRS signal S3, when the content of the electrolyte salt in the electrolytic solution increased, the maximum value of the intensity of the dielectric constant imaginary part increased. More specifically, the maximum value of the dielectric constant imaginary part increased from about 0.5 to about 3.

Further, in the measured DRS signal S3, when the content of the electrolyte salt in the electrolytic solution increased, the intensity of the dielectric constant real part at which the frequency ν became the minimum (=about 0.2 GHZ) increased. More specifically, the intensity of the dielectric constant real part increased from about 3 to about 10.

Meanwhile, in the calculated DRS signal S2, when the content of the electrolyte salt in the electrolytic solution increased, the frequency ν at which the intensity of the dielectric constant imaginary part became the maximum decreased. More specifically, the frequency ν decreased from about 30 GHz to about 0.5 GHz.

In addition, in the calculated DRS signal S2, when the content of the electrolyte salt in the electrolytic solution increased, the maximum value of the intensity of the dielectric constant imaginary part increased. More specifically, the maximum value of the intensity of the dielectric constant imaginary part increased from about 0.5 to about 4.

Further, in the calculated DRS signal S2, when the content of the electrolyte salt in the electrolytic solution increased, the intensity of the dielectric constant real part at which the frequency ν became the minimum (=about 0.2 GHZ) increased. More specifically, the intensity of the dielectric constant real part increased from about 1 to about 10.

Based on the above-described tendencies, the calculated DRS signal S2 and the measured DRS signal S3 qualitatively coincided with each other. Thus, the reliability of the calculated DRS signal S2 with respect to the measured DRS signal S3 was guaranteed, and thus, the reliability of the individually calculated DRS signals S1, which were each a constituent part of the calculated DRS signal S2, was also guaranteed. It was thus possible to assign the measured DRS signal S3, based on the individually calculated DRS signals S1.

The reliability of the calculated DRS signal S2 of the electrolytic solution was guaranteed, and thus, the reliability of the individually calculated DRS signal S1 of each of the constituent components C (the neutral molecule m (DEC) and the ion pairs x (CIP and the ion associate)) was also guaranteed. Accordingly, tendencies similar to those derived in Example 1 were derived from the results illustrated in FIGS. 12 to 15, regarding, for example, the spectrum shape of the measured DRS signal S3, the mobility of the neutral molecule m, the influence of the ion pair x on the spectrum shape, and formation easiness of the ion pair x (CIP).

In particular, the following tendencies were also derived from a result of the comparison between the individually calculated DRS signals S1 regarding the three-component system (in which the constituent components C were the neutral molecule m (DEC) and the ion pairs x (CIP and the ion associate)) illustrated in FIG. 12 and the individually calculated DRS signals S1 regarding the two-component system (in which the constituent components C were the neutral molecule m (DEC) and the ion pair x (CIP)) illustrated in FIG. 13.

As is apparent from FIG. 13, in the calculated DRS signal S2 of the two-component system in which the ion associate was not taken into account as the ion pair x, the intensity of the dielectric constant imaginary part decreased locally in a band where the frequency ν was about 5 GHz, which caused what is called a dip to appear.

In contrast, as is apparent from FIG. 12, in the calculated DRS signal S2 of the three-component system in which the ion associate was also taken into account as the ion pair x, the above-described dip did not appear. Thus, behavior of the dielectric constant imaginary part in a band in which the frequency ν was from about 1 GHz to about 10 GHz both inclusive illustrated in FIG. 12 had tendencies similar to those of the dielectric constant imaginary part of the measured DRS signal S3 in the same band illustrated in FIG. 15. More specifically, the dielectric constant imaginary part in the band varied substantially linearly.

This implied that, inside the electrolytic solution (the content of the electrolyte salt in the electrolytic solution was 1 M) including the solvent (DEC) and the electrolyte salt (LiPF₆), what occurred was not formation of CIP (LiPF₆) resulting from one cation (Li⁺) and one anion (PF₆⁻) coming into proximity to each other, but was formation of a special ion associate (Li₂(PF₆)₂) resulting from two cations (Li⁺) and two anions (PF₆⁻) being associated with each other.

From the above, new and useful information was obtained on the physical property of the electrolytic solution that included the solvent (DEC) and the electrolyte salt (LiPF₆) and accordingly included the neutral molecule m (DEC) and the ion pairs x (CIP and the ion associate) as the constituent components C. In this case, it was confirmed that the physical property of the electrolytic solution was influenced not only by CIP but also by the ion associate. It was thus possible to find out the influence of the ion associate.

In more detail, it was possible to obtain advantages similar to those in Example 1. In this case, it was possible to obtain similar advantages also when focusing on the ion associate in addition to CIP as the ion pair x, in particular.

Based upon the results illustrated in FIGS. 3 to 15, the analysis of the electrolytic solution by the analysis apparatus 100 (the analysis method) guaranteed the reliability of the calculated DRS signal S2 with respect to the measured DRS signal S3, and thus guaranteed the reliability of the individually calculated DRS signals S1, which were each a constituent part of the calculated DRS signal S2. It was thus possible to assign the measured DRS signal S3, based on the individually calculated DRS signals S1. This made it possible to acquire the physical property values P unique to each of the constituent components C, and to find out not only the physical property of the neutral molecule m but also the physical property of the ion pairs x (CIP and the ion associate). Accordingly, it was possible to easily and highly accurately analyze the physical property of the electrolytic solution.

Although the present technology has been described according to an embodiment including Examples, a configuration of the present technology is not limited thereto, and is therefore modifiable in a variety of ways.

The effects described herein are mere examples, and effects of the present technology are therefore not limited to those described herein. Accordingly, the present technology may achieve any other effect.

Note that the present technology may have any of the following configurations according to an embodiment.

<1>

An analysis method including:
calculating dynamical behavior of a series of atoms included in a constituent component of an electrolytic solution by performing a molecular dynamics calculation regarding the electrolytic solution;
calculating a first dielectric relaxation spectrum signal of the constituent component, based on the dynamical behavior of the series of atoms;
calculating a second dielectric relaxation spectrum signal of the electrolytic solution, based on the first dielectric relaxation spectrum signal; and
calculating a physical property value unique to the constituent component, based on the first dielectric relaxation spectrum signal and the second dielectric relaxation spectrum signal.
   <2>

The analysis method according to <1>, in which
the electrolytic solution includes a solvent and an electrolyte salt, and
the constituent component includes at least one kind selected from neutral molecules and ion pairs.
   <3>

The analysis method according to <1> or <2>, in which the physical property value includes at least one of a characteristic time, a relaxation strength, a static dielectric constant, a concentration, or a salt dissociation degree.

<4>

The analysis method according to any one of <1> to <3>, in which
for the calculating of the first dielectric relaxation spectrum signal,
   a total electric dipole moment of the constituent component is calculated based on the dynamical behavior of the series of atoms,
   a time correlation function of the constituent component is calculated based on the total electric dipole moment,
   the time correlation function is fitted with an exponential function, and
   the first dielectric relaxation spectrum signal of the constituent component is calculated by Fourier transforming a result of the approximation of the time correlation function.
      <5>

The analysis method according to any one of <1> to <3>, in which
for the calculating of the first dielectric relaxation spectrum signal,
   an individual electric dipole moment of the constituent component is calculated based on the dynamical behavior of the series of atoms,
   a rotational correlation function of the constituent component is calculated based on the individual electric dipole moment,
   a rotational correlation time of the constituent component is calculated by fitting the rotational correlation function with an exponential function, and
   the first dielectric relaxation spectrum signal of the constituent component is calculated based on the rotational correlation time.
      <6>

The analysis method according to any one of <1> to <5>, in which
the constituent component includes two or more kinds selected from the neutral molecules and the ion pairs,
the first dielectric relaxation spectrum signal of each of the two or more kinds included in the constituent component is calculated, and
the second dielectric relaxation spectrum signal is calculated by adding up the respective first dielectric relaxation spectrum signals of the two or more kinds included in the constituent component.
   <7>

The analysis method according to any one of <1> to <6>, further including:
measuring a third dielectric relaxation spectrum signal of the electrolytic solution by analyzing the electrolytic solution by dielectric relaxation spectroscopy; and
assigning, based on the first dielectric relaxation spectrum signal, the third dielectric relaxation spectrum signal by comparing the second dielectric relaxation spectrum signal and the third dielectric relaxation spectrum signal with each other.
   <8>

The analysis method according to <7>, in which
after the measuring of the third dielectric relaxation spectrum signal, the third dielectric relaxation spectrum signal is corrected by removing, from the third dielectric relaxation spectrum signal, a signal component derived from ionic conductivity of the electrolytic solution, and
the second dielectric relaxation spectrum signal and a result of the correction of the third dielectric relaxation spectrum signal are compared with each other.
   <9>

An analysis apparatus including
a calculator that calculates a physical property value regarding an electrolytic solution, in which
the calculator
   calculates dynamical behavior of a series of atoms included in a constituent component of the electrolytic solution by performing a molecular dynamics calculation regarding the electrolytic solution,
   calculates a first dielectric relaxation spectrum signal of the constituent component, based on the dynamical behavior of the series of atoms,
   calculates a second dielectric relaxation spectrum signal of the electrolytic solution, based on the first dielectric relaxation spectrum signal, and
   calculates the physical property value unique to the constituent component, based on the first dielectric relaxation spectrum signal and the second dielectric relaxation spectrum signal.
      <10>

The analysis apparatus according to <9>, in which
the electrolytic solution includes a solvent and an electrolyte salt, and
the constituent component includes at least one kind selected from neutral molecules and ion pairs.
   <11>

The analysis apparatus according to <9> or <10>, in which the physical property value includes at least one of a characteristic time, a relaxation strength, a static dielectric constant, a concentration, or a salt dissociation degree.

<12>

The analysis apparatus according to any one of <9> to <11>, in which
to calculate the first dielectric relaxation spectrum signal,
the calculator
   calculates a total electric dipole moment of the constituent component, based on the dynamical behavior of the series of atoms,
   calculates a time correlation function of the constituent component, based on the total electric dipole moment,
   fits the time correlation function with an exponential function, and
   calculates the first dielectric relaxation spectrum signal of the constituent component by Fourier transforming a result of the approximation of the time correlation function.
      <13>

The analysis apparatus according to any one of <9> to <11>, in which
to calculate the first dielectric relaxation spectrum signal,
the calculator
   calculates an individual electric dipole moment of the constituent component, based on the dynamical behavior of the series of atoms,
   calculates a rotational correlation function of the constituent component, based on the individual electric dipole moment,
   calculates a rotational correlation time of the constituent component by fitting the rotational correlation function with an exponential function, and
   calculates the first dielectric relaxation spectrum signal of the constituent component, based on the rotational correlation time.
      <14>

The analysis apparatus according to any one of <9> to <13>, in which
the constituent component includes two or more kinds selected from the neutral molecules and the ion pairs, and
the calculator
   calculates the first dielectric relaxation spectrum signal of each of the two or more kinds included in the constituent component, and
   calculates the second dielectric relaxation spectrum signal by adding up the respective first dielectric relaxation spectrum signals of the two or more kinds included in the constituent component.
      <15>

The analysis apparatus according to any one of <9> to <14>, further including:
a measurer that measures a third dielectric relaxation spectrum signal of the electrolytic solution by analyzing the electrolytic solution by dielectric relaxation spectroscopy; and
a comparison device that assigns, based on the first dielectric relaxation spectrum signal, the third dielectric relaxation spectrum signal by comparing the second dielectric relaxation spectrum signal and the third dielectric relaxation spectrum signal with each other.
   <16>

The analysis apparatus according to <15>, in which
the measurer performs, after measuring the third dielectric relaxation spectrum signal, a correction of the third dielectric relaxation spectrum signal by removing, from the third dielectric relaxation spectrum signal, a signal component derived from ionic conductivity of the electrolytic solution, and
the comparison device compares the second dielectric relaxation spectrum signal and a result of the correction of the third dielectric relaxation spectrum signal with each other.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. An analysis method comprising:
calculating dynamical behavior of a series of atoms included in a constituent component of an electrolytic solution by performing a molecular dynamics calculation regarding the electrolytic solution;
calculating a first dielectric relaxation spectrum signal of the constituent component, based on the dynamical behavior of the series of atoms;
calculating a second dielectric relaxation spectrum signal of the electrolytic solution, based on the first dielectric relaxation spectrum signal; and
calculating a physical property value unique to the constituent component, based on the first dielectric relaxation spectrum signal and the second dielectric relaxation spectrum signal.

2. The analysis method according to claim 1, wherein
the electrolytic solution includes a solvent and an electrolyte salt, and
the constituent component includes at least one kind selected from neutral molecules and ion pairs.

3. The analysis method according to claim 1, wherein the physical property value includes at least one of a characteristic time, a relaxation strength, a static dielectric constant, a concentration, or a salt dissociation degree.

4. The analysis method according to claim 1, wherein
for the calculating of the first dielectric relaxation spectrum signal,
a total electric dipole moment of the constituent component is calculated based on the dynamical behavior of the series of atoms,
a time correlation function of the constituent component is calculated based on the total electric dipole moment,
the time correlation function is fitted with an exponential function, and
the first dielectric relaxation spectrum signal of the constituent component is calculated by Fourier transformation of the fitted time correlation function.

5. The analysis method according to claim 1, wherein
for the calculating of the first dielectric relaxation spectrum signal,
an individual electric dipole moment of the constituent component is calculated based on the dynamical behavior of the series of atoms,
a rotational correlation function of the constituent component is calculated based on the individual electric dipole moment,
a rotational correlation time of the constituent component is calculated by fitting the rotational correlation function with an exponential function, and
the first dielectric relaxation spectrum signal of the constituent component is calculated based on the rotational correlation time.

6. The analysis method according to claim 1, wherein
the constituent component includes two or more kinds selected from the neutral molecules and the ion pairs,
the first dielectric relaxation spectrum signal of each of the two or more kinds included in the constituent component is calculated, and
the second dielectric relaxation spectrum signal is calculated by summing up the respective first dielectric relaxation spectrum signals of the two or more kinds included in the constituent component.

7. The analysis method according to claim 1, further comprising:
measuring a third dielectric relaxation spectrum signal of the electrolytic solution by analyzing the electrolytic solution by dielectric relaxation spectroscopy; and
assigning, based on the first dielectric relaxation spectrum signals, the third dielectric relaxation spectrum signal by comparing the second dielectric relaxation spectrum signal and the third dielectric relaxation spectrum signal with each other.

8. The analysis method according to claim 7, wherein
after the measuring of the third dielectric relaxation spectrum signal, the third dielectric relaxation spectrum signal is corrected by removing, from the third dielectric relaxation spectrum signal, a signal component derived from ionic conductivity of the electrolytic solution.

9. An analysis apparatus comprising
a calculator that calculates a physical property value regarding an electrolytic solution, wherein
the calculator
calculates dynamical behavior of a series of atoms included in a constituent component of the electrolytic solution by performing a molecular dynamics calculation regarding the electrolytic solution,
calculates a first dielectric relaxation spectrum signal of the constituent component, based on the dynamical behavior of the series of atoms,
calculates a second dielectric relaxation spectrum signal of the electrolytic solution, based on the first dielectric relaxation spectrum signals, and
calculates the physical property value unique to the constituent component, based on the first dielectric relaxation spectrum signal and the second dielectric relaxation spectrum signal.

10. The analysis apparatus according to claim 9, wherein
the electrolytic solution includes a solvent and an electrolyte salt, and
the constituent component includes at least one kind selected from neutral molecules and ion pairs.

11. The analysis apparatus according to claim 9, wherein the physical property value includes at least one of a characteristic time, a relaxation strength, a static dielectric constant, a concentration, or a salt dissociation degree.

12. The analysis apparatus according to claim 9, wherein
to calculate the first dielectric relaxation spectrum signal,
the calculator
calculates a total electric dipole moment of the constituent component, based on the dynamical behavior of the series of atoms,
calculates a time correlation function of the constituent component, based on the total electric dipole moment,
fits the time correlation function with an exponential function, and
calculates the first dielectric relaxation spectrum signal of the constituent component by Fourier transformation of the fitted time correlation function.

13. The analysis apparatus according to claim 9, wherein
to calculate the first dielectric relaxation spectrum signal,
the calculator
calculates an individual electric dipole moment of the constituent component, based on the dynamical behavior of the series of atoms,
calculates a rotational correlation function of the constituent component, based on the individual electric dipole moment,
calculates a rotational correlation time of the constituent component by fitting the rotational correlation function with an exponential function, and
calculates the first dielectric relaxation spectrum signal of the constituent component, based on the rotational correlation time.

14. The analysis apparatus according to claim 9, wherein
the constituent component includes two or more kinds selected from the neutral molecules and the ion pairs, and
the calculator
calculates the first dielectric relaxation spectrum signal of each of the two or more kinds included in the constituent component, and
calculates the second dielectric relaxation spectrum signal by summing up the respective first dielectric relaxation spectrum signals of the two or more kinds included in the constituent component.

15. The analysis apparatus according to claim 9, further comprising:
a measurer that measures a third dielectric relaxation spectrum signal of the electrolytic solution by analyzing the electrolytic solution by dielectric relaxation spectroscopy; and
a comparison device that assigns, based on the first dielectric relaxation spectrum signal, the third dielectric relaxation spectrum signal by comparing the second dielectric relaxation spectrum signal and the third dielectric relaxation spectrum signal with each other.

16. The analysis apparatus according to claim 15, wherein
the measurer performs, after measuring the third dielectric relaxation spectrum signal, a correction of the third dielectric relaxation spectrum signal by removing, from the third dielectric relaxation spectrum signal, a signal component derived from ionic conductivity of the electrolytic solution.
